(19) United States
(12) Patent Application Publication
(10) Pub. No.: US 2026/0303283 A1
(43) Pub. Date: Oct. 1, 2026

(54) ADJUSTING SYSTEM INFORMATION WINDOWS FOR A NARROWBAND INTERNET-OF-THINGS USER EQUIPMENT IN A NON-TERRESTRIAL NETWORK

(71) Applicant: QUALCOMM Incorporated, San Diego, CA (US)

(72) Inventors: Bharat SHRESTHA, San Diego, CA (US); Alberto RICO ALVARINO, San Diego, CA (US); Umesh PHUYAL, San Diego, CA (US); Ayan SENGUPTA, Mountain View, CA (US)

(21) Appl. No.: 19/451,628

(22) Filed: Jan. 16, 2026

Related U.S. Application Data
(60) Provisional application No. 63/777,552, filed on Mar. 25, 2025.

(51) Int. Cl. H04L 5/00; H04W 72/0446

(52) U.S. Cl. CPC H04L 5/0048; H04W 72/0446

(57) ABSTRACT

Certain aspects of the present disclosure provide techniques for wireless communications. An example method for wireless communications by a user equipment (UE) includes: obtaining, from a network entity, a first system information block (SIB) indicating an adjustment to a system information (SI) window for a second SIB; obtaining, from the network entity, the second SIB in an adjusted SI window that is adjusted from the SI window based on the adjustment; and communicating, with the network entity, in accordance with the second SIB. In some aspects, the UE may be a narrowband Internet-of-Things (NB-IoT) UE.

### CROSS-REFERENCE TO RELATED APPLICATIONS

This Application claims the benefit of and priority to U.S. Provisional Patent Application No. 63/777,552, filed on Mar. 25, 2025, the entire contents of which are hereby incorporated by reference.

### INTRODUCTION

### Field of the Disclosure

Aspects of the present disclosure relate to wireless communications, and more particularly, to techniques for adjusting system information (SI) windows for a user equipment (UE), such as a narrowband Internet-of-Things (NB-IoT) UE in a non-terrestrial network (NTN).

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a user equipment (UE). The method includes obtaining, from a network entity, a first system information block (SIB) indicating an adjustment to a system information (SI) window for a second SIB; obtaining, from the network entity, the second SIB in an adjusted SI window that is adjusted from the SI window based on the adjustment; and communicating, with the network entity, in accordance with the second SIB.

Certain aspects provide a method of wireless communications by a UE. The method includes obtaining, from a network entity, a first SIB indicating a SI window for a second SIB; obtaining, from the network entity, the second SIB in one or more radio frames within the SI window, the UE being configured for obtaining downlink communication in the one or more radio frames; and communicating, with the network entity, in accordance with the second SIB.

Certain aspects provide a method for wireless communications by a network entity. The method includes sending a first SIB indicating an adjustment to a SI window for a second SIB; and sending the second SIB in an adjusted SI window that is adjusted from the SI window based on the adjustment.

Certain aspects provide a method of wireless communications by a network entity. The method includes sending a first SIB indicating a SI window for a second SIB; and sending the second SIB in one or more radio frames within the SI window, the network entity being configured for sending downlink communication in the one or more radio frames.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts an example non-terrestrial network (NTN).

FIG. 6 depicts an example frame format for a narrowband Internet-of-Things (NB-IoT) UE in NTN.

FIG. 7 depicts an example of system information (SI) scheduling for an NB-IoT UE in NTN.

FIG. 8 depicts another example of SI scheduling for an NB-IoT UE in NTN.

FIG. 9 depicts another example of SI scheduling for an NB-IoT UE in NTN.

FIG. 10 depicts a process flow for communications in a network between a network entity and a UE.

FIG. 11 depicts a method for wireless communications.

FIG. 12 depicts another method for wireless communications.

FIG. 13 depicts another method for wireless communications.

FIG. 14 depicts another method for wireless communications.

FIG. 15 depicts aspects of an example communications device.

FIG. 16 depicts aspects of an example communications device.

FIG. 17 depicts aspects of an example communications device.

FIG. 18 depicts aspects of an example communications device.

### DETAILED DESCRIPTION

Aspects of the present disclosure provide apparatuses, methods, processing systems, and computer-readable mediums for adjusting system information (SI) windows for a user equipment (UE), such as a narrowband Internet-of-Things (NB-IoT) UE in a non-terrestrial network (NTN).

NB-IoT is a low-power wide-area network (LPWAN) radio technology developed for cellular network devices (e.g., UEs) and services and limits a bandwidth for communications to a single narrow-band (e.g., of 200 kilohertz (kHz)). NB-IoT may enable communication with “things” that require small amounts of data, over long periods, in hard to reach places, or a combination thereof. NB-IoT provides low power consumption, an extended range, deployment into existing cellular network architectures, network security, network reliability, and lower component costs. For example, NB-IoT may enable communications for many potential “connected things” (e.g., NB-IoT devices) that are located in remote or hard to reach areas and/or are located long distances from a next cellular network entity, such as monitoring meters and sensors located in remote rural areas and/or in shielded areas (e.g., deep within buildings or underground structures).

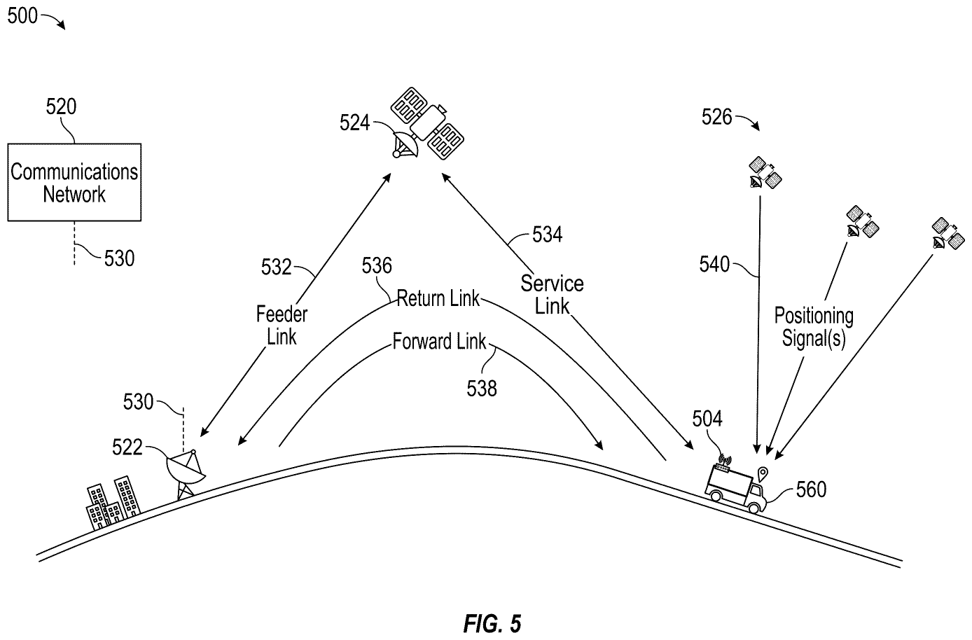

Certain wireless communications systems (e.g., Evolved Universal Terrestrial Radio Access (E-UTRA) systems, 5G New Radio (NR) systems, and/or future wireless communications systems) may facilitate communications coverage via an NTN, such as a spaceborne (e.g., satellite) and/or airborne (e.g., airship, balloon, etc.) platform that provides wireless connectivity to a UE, such as an NB-IoT UE that supports the NB-IoT technology. In certain cases, the NB-IoT in the NTN, when in a time division duplexing (TDD) mode, may support a defined frame periodicity of a particular number of radio frames. The particular number of radio frames may correspond to a number of system frame numbers (SFNs). In certain cases, a unit of a number of radio frames may be referred to as a number of SFNs, and a radio frame may be referred to as an SFN, in the present disclosure. That is, an SFN can identify a radio frame, and a given radio frame identified by the SFN may be referred to as the SFN (e.g., a radio frame identified by SFN 1023 may be referred to as “SFN 1023”). In some cases, a downlink (DL) frame periodicity or an uplink (UL) frame periodicity may be nine radio frames, and a UE (e.g., an NB-IoT UE) may use a subset of a plurality of subframes within the nine radio frames for DL or UL communications. For example, an NB-IoT UE may use a number of specific subframes within the nine radio frames for DL communications. An example frame format used for DL communications is depicted and described herein with reference to FIG. 5. While certain aspects of the present disclosure are described in the context of DL communications for an NB-IoT UE in an NTN, some aspects are not limited to such context, and may be applicable for UL communications and/or for a different type of UE than an NB-IoT UE in an NTN.

Technical problems for DL communications using a frame format described above may include, for example, a low duty cycle. For example, an NB-IoT UE in an NTN may monitor eight subframes (e.g., of ‘valid’ DL SFNs) during a frame periodicity of nine radio frames. This means the NB-IoT UE would monitor 8 milliseconds (ms) out of 90 ms in one frame periodicity for DL communications. Due to such a low duty cycle operation, a scheduled SI window for receiving an SI message (e.g., via a system information block (SIB)) may fall on a subframe (e.g., of an ‘invalid’ DL SFN) that is not monitored for DL communications. The SI message may be received via one or more SIBs that include, for example, cell re-selection information. When a scheduled SI window falls on an invalid DL SFN, the SI message scheduled for such SI window may be postponed or dropped, potentially resulting in increased latency for obtaining the SI message and/or other reduced data communications performance.

Aspects described herein may overcome the aforementioned technical problems, for example, by providing a technique for adjusting a scheduled SI window. Certain aspects may adjust the scheduled SI window such that an SI message (e.g., including a retransmission or a repetition of the SI message) may be received by a UE within the adjusted SI window. For example, a UE may receive an SI message (e.g., using one or more retransmissions of the SI message) in an adjusted SI window (e.g., in a valid DL SFN, or in a valid DL subframe in the valid DL SFN, within the adjusted SI window), rather than waiting through one or more frame periodicities to receive the SI message.

Certain techniques for adjusting an SI window described herein may provide various beneficial technical effects and/or advantages. The techniques for adjusting an SI window may enable improved wireless communications performance, such as reduced latency for obtaining an SI message, potentially resulting in improved data rate, etc. The reduced latency for obtaining an SI message, as well as improved data rate, etc., may be attributable to the SI message being obtained by a UE earlier when compared to having no adjustment to the SI window which may fall on an invalid DL SFN as described above. For example, due to the adjusted SI window described herein, a UE may obtain an SI message without having to wait through one or more frame periodicities for DL communications, such that the UE may select or re-select a cell for improved data rate, etc. earlier than otherwise possible.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

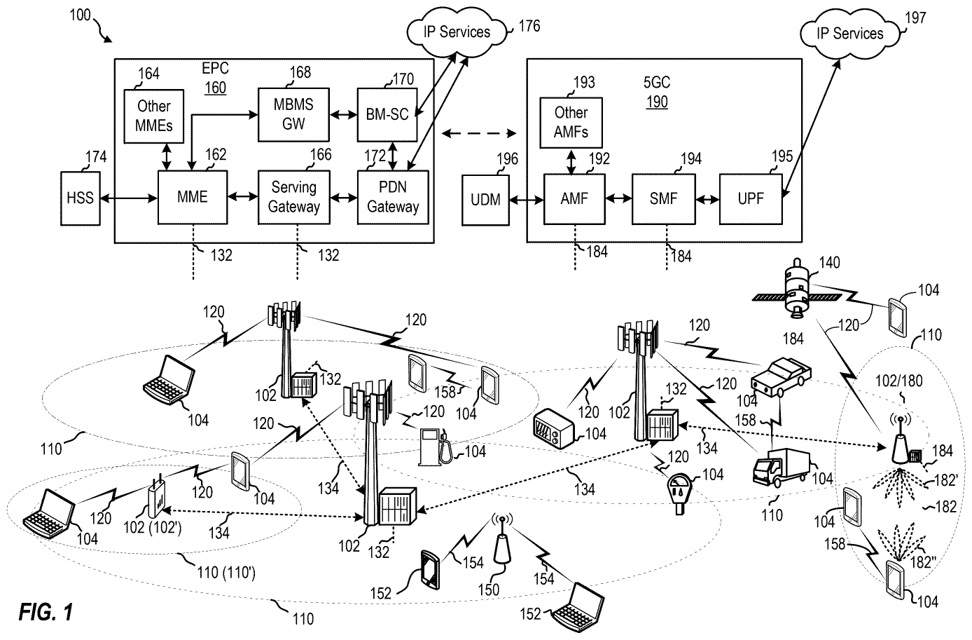

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

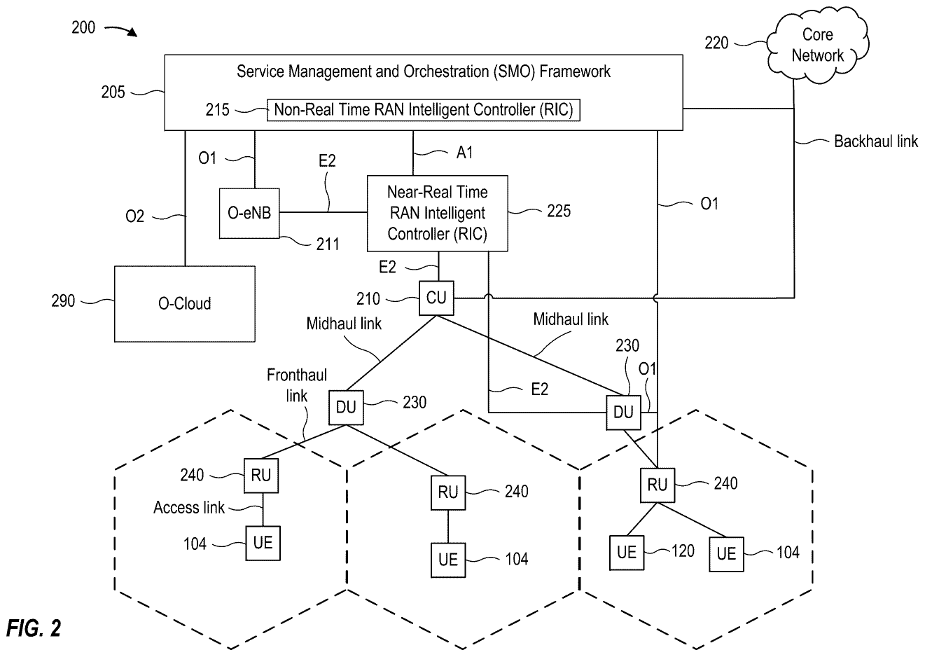

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7,125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz 71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a Wi-Fi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information. 5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

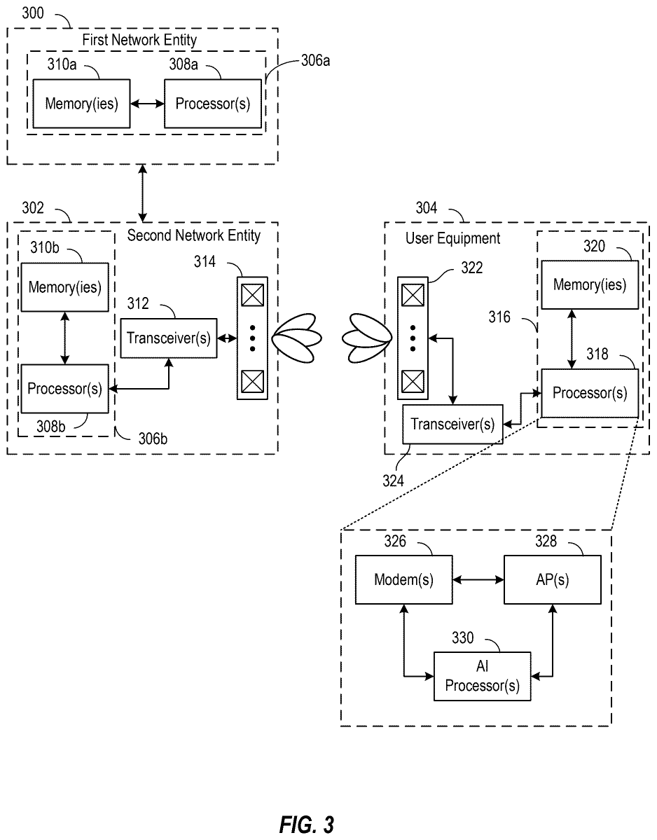

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In s ome examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

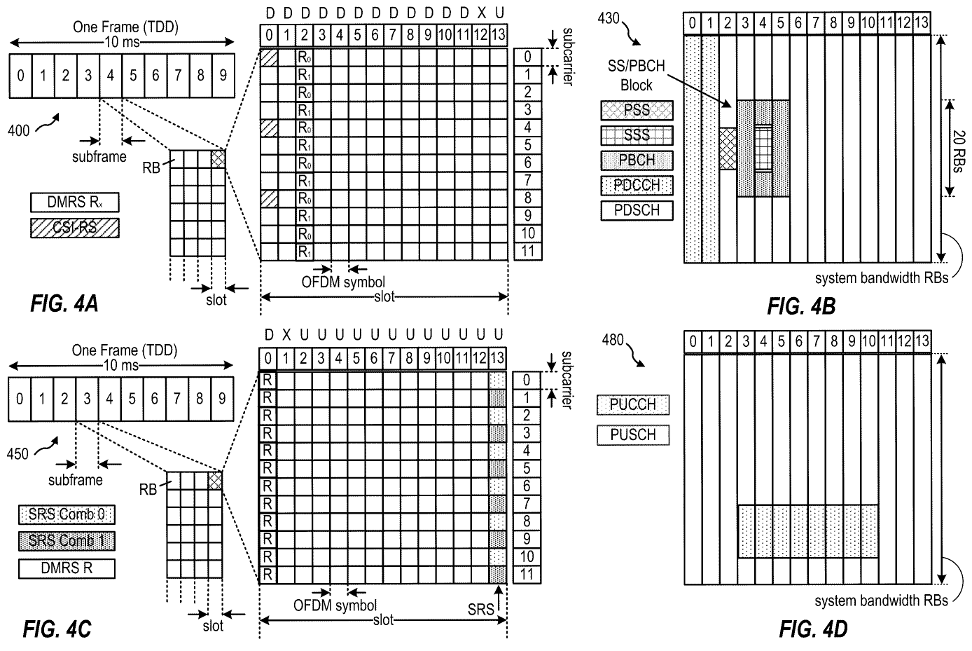

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2^{μ}slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIG. 1 and UE 304 of FIG. 3). The RS may include a demodulation RS (DMRS) and/or a channel state information reference signal (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., UE 104 of FIG. 1 and UE 304 of FIG. 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Non-terrestrial Network Communications

FIG. 5 depicts an example NTN 500. In this example, the NTN 500 includes a communications network 520 (e.g., the EPC 160 and/or the 5GC network 190 of FIG. 1), an NTN gateway 522, and an NTN payload 524. The NTN 500 may facilitate wireless communications with one or more UEs 504 (e.g., the UE 104 of FIG. 1). As an example, the UE 504 may be or include an IoT sensor and/or identification tag affixed to a vehicle 560. The NTN 500 may allow the UE 504 to be in a coverage area for wireless communications even where the vehicle 560 travels great distances, for example, across one or more countries, or is stationed in certain locations lacking a terrestrial communications network. Note that an IoT device is an example of a UE, and other UEs may be capable of NTN communications.

The NTN gateway 522 may communicate with the communications network 520 via one or more interfaces 530, such as backhaul links including NG interface(s) and/or S1 interface(s) between a RAN and a core network. The interface(s) 530 may include wired and/or wireless connections. The NTN gateway 522 may serve one or more NTN payloads 524. In certain aspects, the NTN gateway 522 may be co-located with or include a base station or a disaggregated network entity thereof.

The NTN payload 524 may be or include one or more airborne platforms (e.g., a drone or balloon) and/or one or more spaceborne platforms (e.g., the satellite 140 as depicted in FIG. 1). The NTN payload 524 may be served by one or more NTN gateways 522. In certain aspects, the NTN payload 524 may include any of various non-terrestrial network entities and/or platforms that provide radio access through Geosynchronous Orbit (GSO), Non-Geosynchronous Orbit (NGSO) (which includes Low-Earth Orbit (LEO) and Medium Earth Orbit (MEO)), or High Altitude Platform System (HAPS).

The NTN payload 524 may transparently forward communications (e.g., the radio protocol) received from the UE 504 (via a service link 534) to the NTN gateway 522 (via a feeder link 532), and/or vice-versa. The NTN gateway 522 and the NTN payload 524 may communicate via a wireless communication link referred to as the feeder link 532, and the NTN payload 524 may communicate with the UE 504 via a wireless communication link referred to as the service link 534. In some cases, the transparent links between the NTN gateway 522 and the UE 504 may be referred to as a return link 536 for communications from the UE 504 to the NTN gateway 522 and as a forward link 538 for communications from the NTN gateway 522 to the UE 504. In certain aspects, for communications from the NTN gateway 522, the NTN payload 524 may change the carrier frequency used on the feeder link 532, before re-transmitting the communications on the service link 534, and/or vice versa (respectively on the feeder link).

The service link 534 may include an Earth-fixed service link, a quasi-Earth-fixed service link, and/or an Earth-moving service link. An Earth-fixed service link may be implemented by beam(s) continuously covering the same geographical area(s) all the time (e.g., the case of GSO satellites). A quasi-Earth-fixed service link may be provisioned by beam(s) covering one geographic area for a limited period and a different geographic area during another period (e.g., the case of NGSO satellites generating steerable beams). An Earth-moving service link may be provisioned by beam(s) with a coverage area that slides over the Earth surface (e.g., the case of NGSO satellites generating fixed or non-steerable beams).

In certain aspects, the UE 504 may be in communication with a global navigation satellite system (GNSS) 526. For example, the UE 504 may receive positioning signal(s) 540 from the GNSS 526, and the positioning signal(s) 540 may provide certain information for synchronizing (e.g., time and/or frequency synchronization) the service link 534. The UE 504 may obtain an indication of the location of the NTN payload 524 via system information from the NTN payload 524. In certain cases, the UE 504 may estimate a timing delay and/or Doppler effects associated with the service link 534 using the positioning signal(s) 540 and the location of the NTN payload 524.

### Aspects Related to Adjusting System Information Windows for a Narrowband Internet-of-Things User Equipment in a Non-Terrestrial Network

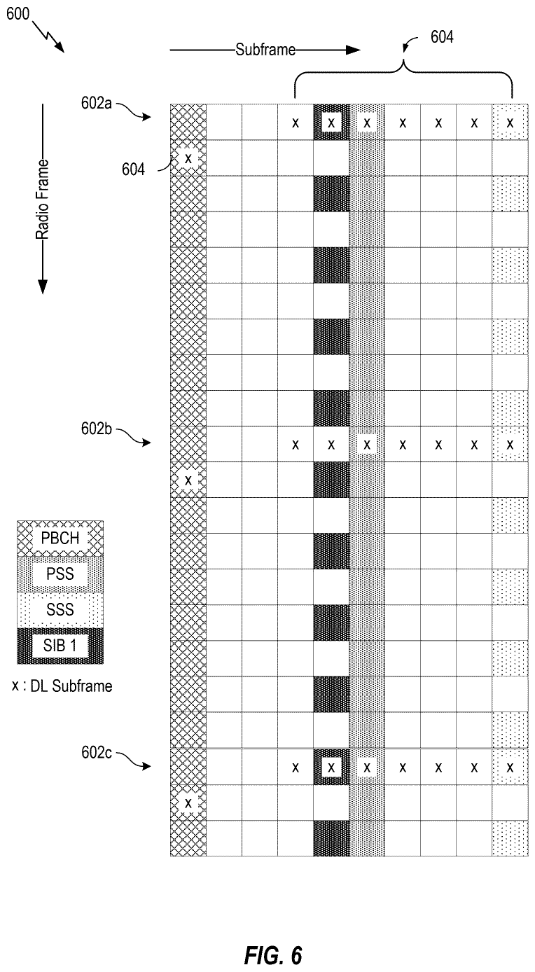

FIG. 6 depicts an example frame format 600 for an NB-IoT UE in NTN.

Certain wireless communications systems (e.g., E-UTRA systems, 5G NR systems, and/or future wireless communications systems) may facilitate communications coverage via an NTN, such as a spaceborne (e.g., satellite) and/or airborne (e.g., airship, balloon, etc.) platform that provides wireless connectivity to a UE, such as an NB-IoT UE. In certain cases, the NB-IoT in the NTN, when in a TDD mode, may support a defined frame periodicity (e.g., SI periodicity) of a particular number of radio frames. The particular number of radio frames may correspond to a number of SFNs. In some cases, a DL frame periodicity or a UL frame periodicity may be nine radio frames (e.g., nine SFNs), while an SFN cycle (e.g., a Hyper-SFN (H-SFN) duration) may be 1,024 radio frames (e.g., 10,240 subframes, or 10.24 seconds). A UE (e.g., an NB-IoT UE) may use a subset of a plurality of subframes within the nine radio frames of a defined frame periodicity for DL or UL communications.

The depicted example frame format 600 includes a plurality of radio frames corresponding to a plurality SFNs, such as SFN 0(602a ), SFN 9 (602 b), and SFN 18 (602c). Each SFN includes ten subframes. In the depicted example frame format 600, certain subframes are used for obtaining PBCH, PSS, SSS, and SIB1 (e.g., including information regarding the availability and scheduling of other SIBs), respectively. As depicted, the example frame format 600 includes eight DL subframes (604, marked by an “x” in FIG. 6) to obtain DL communications for each frame periodicity of nine SFNs. In the depicted example, the eight DL subframes 604 for the first frame periodicity (e.g., corresponding to SFNs 0-8) include subframe 3, subframe 4, subframe 5, subframe 6, subframe 7, subframe 8, and subframe 9 of SFN 0 and subframe 0 of SFN 1. Accordingly, 82 subframes of the first frame periodicity (e.g., having 90 subframes) are not used for DL communications.

Due to a low duty cycle operation for DL communications (e.g., using eight subframes out of 90 subframes), a scheduled SI window for obtaining an SI message may fall on subframes that are not part of the eight DL subframes 604. The SFNs including the subframes that are not part of the eight DL subframes 604 may be referred as invalid DL SFNs (where their subframes may be referred to as invalid DL subframes), and the SFNs including the eight DL subframes 604 maybe referred to as valid DL SFNs (where the eight DL subframes 604 may be referred to as valid DL subframes). When an SI window falls on an invalid DL SFN, an SI message may be postponed or dropped. In certain cases, Layer 2 or Layer 3 signaling, such as RRC signaling, may be used for, for example, adjusting the SI window, such as to enable an NB-IoT UE to obtain the SI message with reduced latency (e.g., when compared to waiting to receive the SI message in a subsequent SI window that falls on a valid DL SFN). In certain aspects, there may not be a change in the way an SI window is scheduled (e.g., via SIB1) and started. In some cases, the SIB1 may include an additional indication to adjust the start or the end of a scheduled SI window, where the scheduled SI window with the adjustment may be referred to as an adjusted SI window.

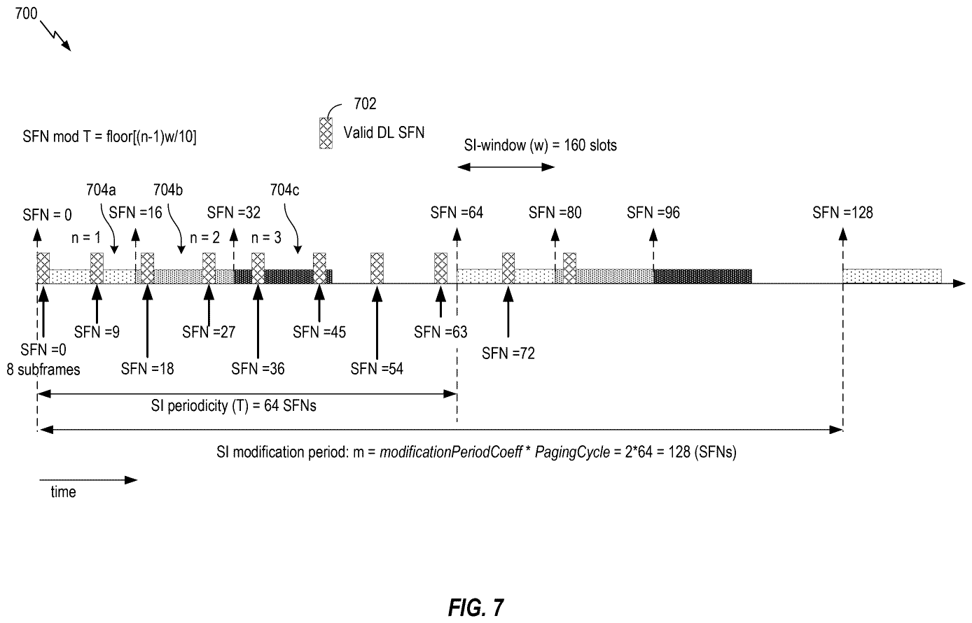

FIG. 7 depicts an example 700 of SI scheduling for an NB-IoT UE in NTN.

For an NB-IoT UE in NTN, a start of an SI window may be determined as follows. The SI window starts at subframe 0 in a radio frame for which (H-SFN*1024+SFN) mod T=FLOOR(x/10)+Offset. T is the SI periodicity of a corresponding SI message. Offset is an offset of the start of the SI window. x=(n−1)*w, where w is an SI window length, and n corresponds to an order of entry in a concatenated list of SI messages. In certain cases, the minimum value of the SI window length for an NB-IoT device is 160 ms, and the minimum SI periodicity is 640 ms (e.g., 64 SFNs). As 1,024 (e.g., a number of radio frames in an H-SFN duration) is not a multiple of 9, an SI window for obtaining an SI message (e.g., an SIB) may not necessarily fall on a valid DL SFN, where scheduling is fixed and an NB-IoT device may not monitor SI-radio network temporary identifier (RNTI) within an SI window. The example 700 also depicts an SI modification period during which a retransmission of an SI message or a notification of a change of an SI message (and potentially an updated SI message) may be obtained. As depicted, an SI modification period (m) may be a product of a modification period coefficient (depicted as modificationPeriodCoeff) and a paging cycle (depicted as PagingCycle), where the SI modification period in the depicted example 700 is 128 SFNs. Various parameters such as those described above, including the SI window length, the modification period coefficient, the paging cycle, etc. are provided and obtained by a UE (e.g., an NB-IoT UE) in SIB1.

In some cases, an NB-IoT UE may use two (or more) valid DL SFNs (702) to allow for a retransmission of an SI message. Thus, an SI window that falls on two (or more) valid DL SFNs 702 may be used by an NB-IoT UE to obtain an SI message. As depicted in FIG. 7, in some cases, an SI window (704a, 704b, or 704c) may fall on (e.g., coincide or overlap with) only one valid DL SFN (and not according to a scheduling based on a transport block size). Accordingly, at least a portion of an SI message may need to be postponed or dropped, potentially resulting in increased latency for obtaining an SI message and reduced data communications performance. An SI window (704a, 704b, or 704c) may be scheduled for obtaining one or more SIBs, such as NTN SIB31 (e.g., including satellite position and velocity information) or other known SIBs. In some cases, an SI window (704a, 704b, or 704c) may be scheduled for obtaining one or more SIBs of a group of SIBs, such as a group of SIB2 and SIB3 or a group of SIB4, SIB5, and SIB6.

In some aspects, no adjustment (e.g., shifting) of SI window may occur. For example, only valid DL SFNs that are within a SI window (e.g., a scheduled SI window) may be used to obtain an SI message. In certain cases, an NB-IoT UE may obtain, from a network entity, a first SIB (e.g., SIB1) indicating an SI window for a second SIB. Then, the NB-IoT UE may obtain, from the network entity, the second SIB in one or more radio frames within the SI window, where the NB-IoT UE may be configured for obtaining DL communication in the one or more radio frames (e.g., valid DL SFNs). The NB-IoT UE may then communicate, with the network entity for example, in accordance with the second SIB. In certain aspects, the second SIB described herein may be any SIB other than SIB1.

In certain cases, obtaining the second SIB in the one or more radio frames within the SI window may include obtaining the second SIB in a subsequent downlink subframe of a plurality of subsequent downlink subframes of a subsequent radio frame within the SI window, where the subsequent radio frame may follow a first radio frame in which the first SIB is obtained. For example, the resource for the SI message may be the next valid DL subframe of a plurality of subsequent valid DL subframes of the next valid DL SFN within the SI window, and a retransmission (e.g., a repetition) of the SI message may continue in the next valid DL SFN within the SI window (e.g., the same SI window). Accordingly, obtaining the second SIB in the one or more radio frames within the SI window may also include obtaining a retransmission of the second SIB in a second radio frame within the SI window, where the second radio frame may follow the subsequent radio frame.

In certain cases, obtaining the second SIB in the one or more radio frames within the SI window may include ignoring a retransmission of the second SIB outside of the SI window. For example, a retransmission of the SI message outside of the SI window may be dropped. In some cases, the NB-IoT UE may obtain, from the network entity, a retransmission of the SIB within a subsequent SI window after a SI periodicity. For example, the same SI message may be obtained in the subsequent SI window after the SI periodicity. In some cases, an SI window of a length of 160 ms may include only one valid DL SFN, which may not be sufficient for obtaining a retransmission of an SI message.

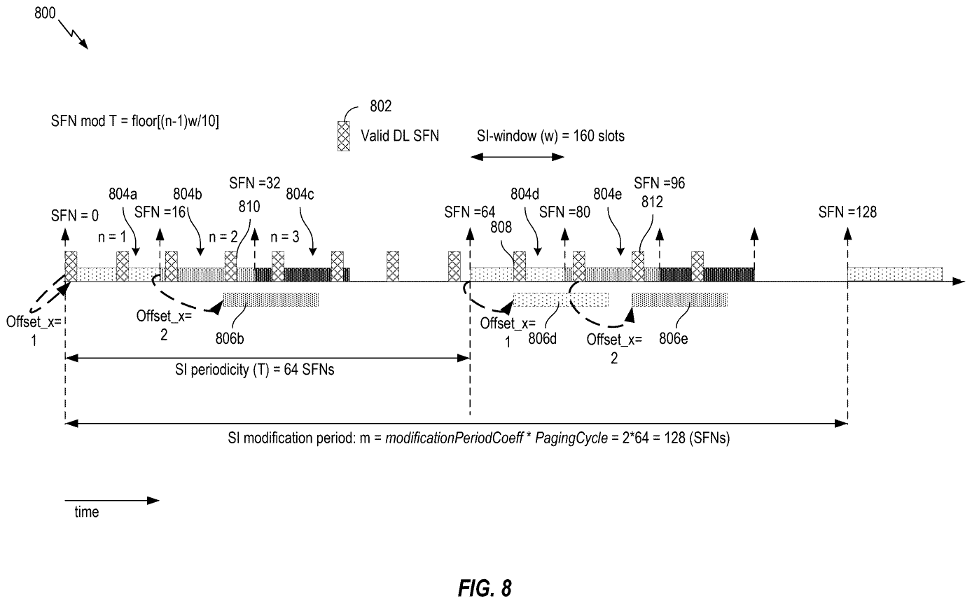

FIG. 8 depicts another example 800 of SI scheduling for an NB-IoT UE in NTN. The example 800 includes a plurality of valid DL SFNs 802 (similar to valid DL SFNs 702 of FIG. 7) and a number of SI windows 804a, 804b, 804c, 804d, 804e (similar to SI windows 704a, 704b, 704c of FIG. 7).

In certain aspects, an SI window for obtaining an SI message may be adjusted based on an offset (e.g., an offset specific to a particular SI window). If any SI message (e.g., a retransmission of an SI message) cannot be obtained in an SI window, such as due to not having enough valid DL SFN coinciding with the SI window, the remaining (e.g., not yet obtained) SI message or retransmission(s) of the SI message may be postponed to subsequent valid DL subframes of subsequent (e.g., immediately subsequent) valid DL SFNs, which may be achieved by sliding or shifting a subsequent SI window based on an offset.

In some aspects, for an SI window X, the corresponding offset may be X. For example, for SI window 1, the corresponding offset may be 1; for SI window 2, the corresponding offset may be 2; etc. The number X of SI window may correspond to an order of a corresponding SI message in an ordered list of SI messages within an SI periodicity. When the offset is 1, the start of the corresponding SI window may be shifted to a first valid DL SFN of subsequent valid DL SFNs, which in some cases may be the current valid DL SFN (thus involving no actual shift). For example, for SI window 804a (where its corresponding offset is 1), no actual shifting may occur, and the start of the SI window 804a stays at SFN 0. For SI window 804d (where its corresponding offset is 1), which does not start at a valid DL SFN 802, the start of the SI window may be shifted to the first valid DL SFN of subsequent valid DL SFNs—SFN 808. Accordingly, the SI window 804d may be shifted to an adjusted SI window 806d.

When the offset is 2, the start of the corresponding SI window may be shifted to a second valid DL SFN of subsequent valid DL SFNs, such as to skip a first valid DL SFN of the subsequent valid DL SFNs. For example, for SI window 804b (where its corresponding offset is 2), the start of the SI window may be shifted to the second valid DL SFN of subsequent valid DL SFNs—SFN 810. Accordingly, the SI window 804b may be shifted to an adjusted SI window 806b. Similarly, SI window 804e may be shifted to an adjusted SI window 806e which starts at SFN 812.

In certain aspects, a network entity may configure an offset for each SI message (e.g., based on a number of retransmissions), such as to avoid the overlapping of postponed retransmission of an SI message with a subsequent SI window. In some cases, the SI window may not be shifted beyond an SI periodicity or an SI modification period. Any SFN for a retransmission that exceeds the SI periodicity or the SI modification period may be dropped, while the last valid DL SFN (e.g., including the last valid DL subframe) of a shifted SI window may exceed the SI periodicity or the SI modification period, as this last valid DL subframe would not overlap with a subsequent valid DL subframe of a subsequent SI periodicity or SI modification period. This is because the first valid DL subframe of the first valid DL SFN would be the fourth subframe (subframe 3) of that SFN. The shifting of SI window allows an NB-IoT UE to obtain an SI message (including a retransmission) without the SI message (e.g., the retransmission) being postponed to a subsequent SI periodicity, reducing latency for obtaining the SI message.

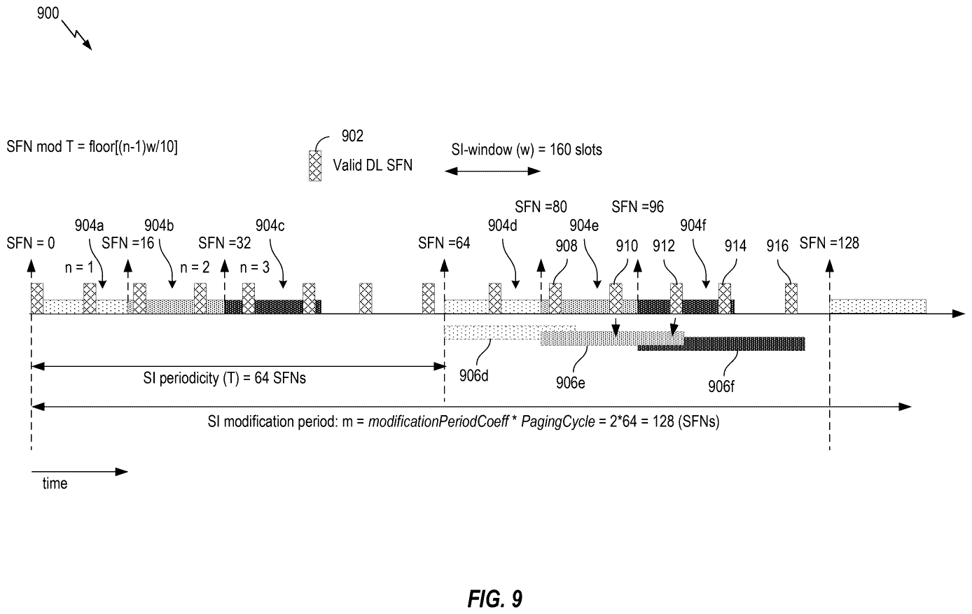

FIG. 9 depicts another example 900 of SI scheduling for an NB-IoT UE in NTN. The example 900 includes a plurality of valid DL SFNs 902 (similar to valid DL SFNs 702 of FIG. 7) and a number of SI windows 904a, 904b, 904c, 904d, 904e, 904f (similar to SI windows 704a, 704b, 704c of FIG. 7).

In certain aspects, an SI window length may be defined in terms of a number of valid DL SFNs. For example, if an SI window length is 2 (as in the depicted example 900), then an SI window includes 2 valid and non-overlapping DL SFNs. Accordingly, all SI windows are extended in length until each SI window includes 2 valid and non-overlapping DL SFNs, where the extend (e.g., adjusted) SI window may override a subsequent SI window.

For example, in the depicted example 900 where an SI window length is 2 (e.g., 2 valid and non-overlapping DL SFNs), SI window 904d, which has one valid DL SFN 902 is extended to adjusted SI window 906d. The adjusted SI window 906d includes SFN 908, which is the first valid DL SFN of SI window 904e. Accordingly, two valid and non-overlapping DL SFNs (including SFN 908) may be used for obtaining an SI message associated with SI window 904d. Similarly, SI window 904e may be extended to adjusted SI window 906e. As SFN 908 (part of SI window 904e) is used for adjusted SI window 906d, SI window 904e may be extended to include not only SFN 910 (included in SI window 904e) but also SFN 912 (of SI window 904f), such that adjusted SI window 906e includes two valid and non-overlapping DL SFNs. Moreover, SI window 904f may be extended to adjusted SI window 906f, to include valid and non-overlapping DL SFNs 914 and 916. A network entity may configure via SIB1 to indicate a number of valid and non-overlapping DL SFNs (e.g., 1 or more) that each SI window is to include.

Similar to the adjustment of SI window described herein with reference to FIG. 7, a network entity may configure an extension for each SI window, such as to avoid the overlapping of an extended SI window with a subsequent SI periodicity or SI modification period. Any SFN of an extended SI window that exceeds the SI periodicity or the SI modification period may be dropped, while the last valid DL SFN (e.g., including the last valid DL subframe) of an extended SI window may exceed the SI periodicity or the SI modification period, as this last valid DL subframe would not overlap with a subsequent valid DL subframe of a subsequent SI periodicity or SI modification period. This is because the first valid DL subframe of the first valid DL SFN would be the fourth subframe (subframe 3) of that SFN.

In certain aspects, an SI window length may be defined in terms of a number of valid DL subframes. For example, an SI window may be extended to include a number of valid DL subframes that corresponds to a number of transmissions for an SI message or a total number of transmissions scheduled for an SI window. In some cases, an SI window may be continually extended until the SI window includes a defined number of valid DL subframes. In certain cases, an existing (e.g., a predefined) transmission or retransmission pattern of an SI message may be ignored, where the existing pattern may indicate starting radio frames within an SI window used for SI message transmission, and a defined value may correspond to a number of radio frames. The transmission or retransmission of an SI message may depend on a configured number of valid DL subframes or valid DL SFNs.

The extension of an SI window allows an NB-IoT UE to obtain an SI message (including a retransmission) without the SI message (e.g., the retransmission) being postponed to a subsequent SI periodicity, reducing latency for obtaining the SI message.

### Example Signaling of Adjusting System Information Windows for a Narrowband Internet-of-Things User Equipment in a Non-Terrestrial Network

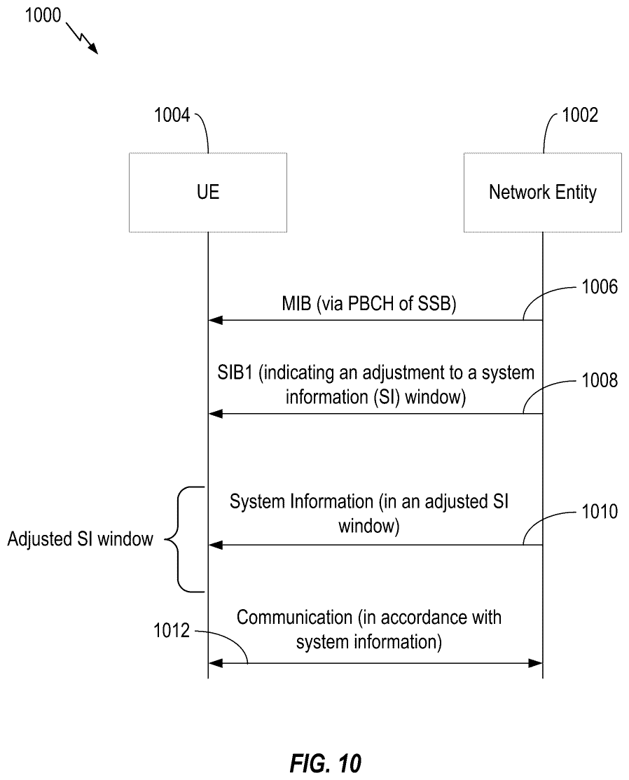

FIG. 10 depicts a process flow for communications in a network between a network entity and a UE.

FIG. 10 depicts a process flow 1000 for communications in a network between a network entity 1002 and a UE 1004. In some aspects, the network entity 1002 may be an example of the BS 102 depicted and described with respect to FIG. 1, the first network entity 300 or the second network entity 302 depicted and described with respect to FIG. 3, or a disaggregated base station depicted and described with respect to FIG. 2. In certain aspects, the network entity 1002 may be an example of the NTN payload 524 depicted and described with respect to FIG. 5. Similarly, the UE 1004 may be an example of UE 104 depicted and described with respect to FIG. 1, the UE 304 depicted and described with respect to FIG. 3, or the UE 504 depicted and described with respect to FIG. 5. However, in other aspects, UE 1004 may be another type of wireless communications device and network entity 1002 may be another type of network entity or network node, such as those described herein. Note that any operations or signaling illustrated with dashed lines may indicate that that operation or signaling is an optional or alternative example.

At 1006, UE 1004 obtains, from network entity 1002, an MIB via PBCH of SSB. The MIB provides information for initial access and for acquiring other system information (e.g., SIB1), including parameters used, for example, for scheduling a PDSCH for acquiring SIB1. The SIB1 includes information regarding the availability and scheduling of other SIBs.

At 1008, UE 1004 obtains, from network entity 1002, a first SIB (e.g., SIB1) indicating an adjustment to an SI window for a second SIB.

In certain aspects, the adjustment to the SI window is based on an offset value that is specific to the SI window, such as the offset described herein with reference to FIG. 8. In some cases, the adjusted SI window, when the offset value is one, starts at a first radio frame or a second radio frame. The first radio frame may be a radio frame in which the second SIB is obtained (e.g. SFN 0 for SI window 804a described herein with reference to FIG. 8). The second radio frame may be an immediately following radio frame that immediately follows a start of the SI window (e.g., SFN 808 of FIG. 8).

In some cases, the adjusted SI window, when the offset value is greater than one, starts at a radio frame that is immediately after a number of radio frames, the number being one less than the offset value. The number of radio frames may include a first radio frame or a second radio frame, where the first radio frame may be a radio frame in which the second SIB is obtained, and the second radio frame may be an immediately following radio frame that immediately follows a start of the SI window. For example, when the offset value is two (e.g., as for SI windows 804b, 804e in the depicted example 800 of FIG. 8), the adjusted SI window may start at a radio frame that is immediately after one radio frame. An example of such adjusted SI window is described herein with reference to adjusted SI windows 806b, 806e of FIG. 8.

In some cases, the offset value is based on a configured number of retransmissions of the second SIB. For example, the network entity 1002 may configure the UE 1004 with a configured number of retransmissions of the second SIB, as well as an offset value according to the configured number of retransmissions.

In some aspects, the adjusted SI window is within a configured SI periodicity. In some aspects, the adjusted SI window is within a configured SI modification period. The configured SI periodicity and/or the configured SI modification period may be obtained by the UE 1004 in an SIB (e.g., SIB1), or determined by the UE 1004 based on information included in an SIB, such as SIB1, such as described with reference to FIG. 7.

In certain aspects, the adjustment may include an extension of a SI window length of the SI window. For example, the extension of the SI window length may include an extension to include a configured number of non-overlapping radio frames (e.g., valid and non-overlapping DL SFNs described herein with reference to FIG. 9). UE 1004 may obtain a plurality of SIBs associated with a plurality of respective SI windows, where the adjustment may include an extension of a respective SI window length of each SI window, of the plurality of respective SI windows, to include the configured number of non-overlapping radio frames. In some cases, the adjusted SI window may include an overlapping portion that overlaps another SI window associated with a third SIB, and UE 1004 may obtain the second SIB in the overlapping portion. In certain cases, the first SIB may include an indication of the configured number of non-overlapping radio frames.

In some aspects, the adjusted SI window is within a configured SI periodicity. In some aspects, the adjusted SI window is within a configured SI modification period. The configured SI periodicity and/or the configured SI modification period may be obtained by the UE 1004 in an SIB (e.g., SIB1), or determined by the UE 1004 based on information included in an SIB, such as SIB1, such as described with reference to FIG. 7.

In certain aspects, the extension of the SI window length may include an extension to include a configured number of downlink subframes for obtaining the second SIB, such as described herein with reference to FIG. 9. For example, the configured number of downlink subframes may be based on a configured number of retransmissions for the second SIB.

At 1010, UE 1004 obtains, from network entity 1002, the second SIB (e.g., system information) in an adjusted SI window that is adjusted from the SI window based on the adjustment.

In certain cases, UE 1004 may obtain one or more retransmissions of the second SIB, of the configured number of retransmissions of the second SIB, outside of the SI window. An example of such retransmission may be the last valid DL SFN of an adjusted SI window, where, for example, one valid DL subframe may exceed the SI window, and not overlap with a subsequent valid DL subframe of a subsequent SI window, as described herein with reference to FIG. 8.

In some aspects, when the extension of the SI window length includes an extension to include a configured number of non-overlapping radio frames, UE 1004 may obtain at least a part of the second SIB in a subframe outside of a configured SI periodicity. In some aspects, when the extension of the SI window length includes an extension to include a configured number of non-overlapping radio frames, UE 1004 may obtain at least a part of the second SIB in a subframe outside of a configured SI modification period. For example, the part of the second SIB obtained in a subframe outside of the configured SI periodicity or the configured SI modification period may include remaining retransmission(s) of the second SIB.

In some aspects, when the extension of the SI window length includes an extension to include a configured number of downlink subframes for obtaining the second SIB, UE 1004 may obtain at least a part of the second SIB in a subframe outside of a configured SI periodicity. In some aspects, when the extension of the SI window length includes an extension to include a configured number of downlink subframes for obtaining the second SIB, UE 1004 may obtain at least a part of the second SIB in a subframe outside of a configured SI modification period.

At 1012, UE 1004 communicates, with network entity 1002, in accordance with the second SIB.

Note that the process flow illustrated in FIG. 10 is an example of adjusting an SI window for an NB-IoT UE in NTN, and aspects of the present disclosure may be applied to adjusting an SI window for an NB-IoT UE in NTN. Note that the process flow illustrated in FIG. 10 is described herein to facilitate an understanding of adjusting an SI window for an NB-IoT UE in NTN, and aspects of the present disclosure may be performed in various manners via alternative or additional signaling and/or operations. In certain aspects, the operations and/or signaling of FIG. 10 may occur in an order different from that described or depicted, and various actions, operations, and/or signaling may be added, omitted, or combined.

### Example Operations of a User Equipment

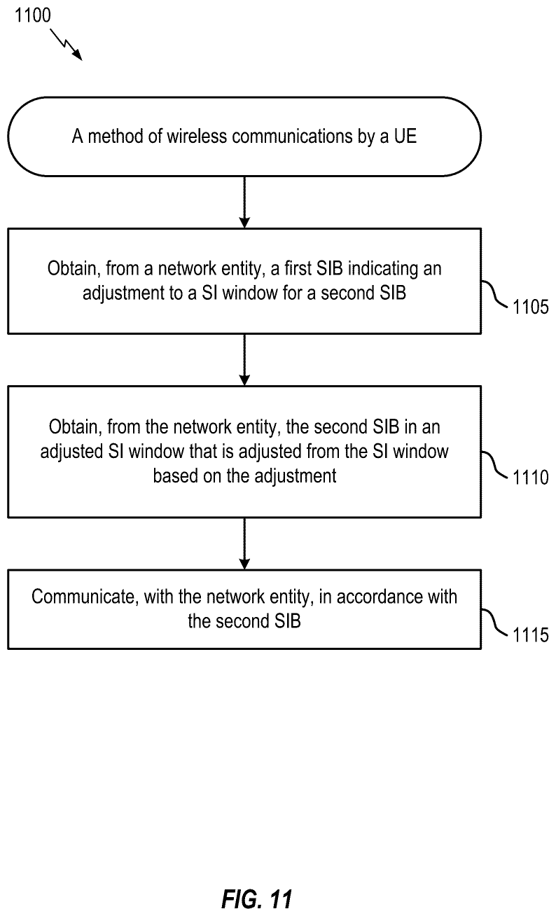

FIG. 11 shows a method 1100 for wireless communications by a UE (e.g., a NB-IoT UE), such as UE 104 of FIG. 1, UE 304 of FIG. 3, UE 504 of FIG. 5, or UE 1004 of FIG. 10.

Method 1100 begins at block 1105 with obtaining, from a network entity, a first SIB indicating an adjustment to a SI window for a second SIB. In some aspects, obtaining the first SIB at block 1105 may be an example of UE 1004 obtaining a first SIB indicating an adjustment to an SI window for a second SIB, as described with respect to 1008 of FIG. 10.

Method 1100 then proceeds to block 1110 with obtaining, from the network entity, the second SIB in an adjusted SI window that is adjusted from the SI window based on the adjustment. In some aspects, obtaining the second SIB in the adjusted SI window at block 1110 may be an example of UE 1004 obtaining a second SIB in an adjusted SI window, as described with respect to 1010 of FIG. 10.

Method 1100 then proceeds to block 1115 with communicating, with the network entity, in accordance with the second SIB. In some aspects, communicating with the network entity in accordance with the second SIB may be an example of UE 1004 communicating with network entity 1002 in accordance with the second SIB, as described with respect to 1012 of FIG. 10.

In some aspects, the adjustment to the SI window is based on an offset value that is specific to the SI window, such as described herein with reference to FIG. 8.

In some aspects, the adjusted SI window, when the offset value is one, starts at a first radio frame or a second radio frame, the first radio frame being a radio frame in which the second SIB is obtained, the second radio frame being an immediately following radio frame that immediately follows a start of the SI window.

In some aspects, the adjusted SI window, when the offset value is greater than one, starts at a radio frame that is immediately after a number of radio frames, the number being one less than the offset value, the number of radio frames comprising a first radio frame or a second radio frame, the first radio frame being a radio frame in which the second SIB is obtained, the second radio frame being an immediately following radio frame that immediately follows a start of the SI window.

In some aspects, the offset value is based on a configured number of retransmissions of the second SIB.

In some aspects, method 1100 further includes obtaining one or more retransmissions of the second SIB, of the configured number of retransmissions of the second SIB, outside of the SI window.

In some aspects, the adjusted SI window is within a configured SI periodicity.

In some aspects, the adjusted SI window is within a configured SI modification period.

In some aspects, block 1110 includes obtaining at least a part of the second SIB in a subframe outside of a configured SI periodicity.

In some aspects, block 1110 includes obtaining at least a part of the second SIB in a subframe outside of a configured SI modification period.

In some aspects, the adjustment comprises an extension of a SI window length of the SI window, such as described herein with reference to FIG. 9.

In some aspects, the extension of the SI window length comprises an extension to include a configured number of non-overlapping radio frames.

In some aspects, block 1110 includes obtaining a plurality of SIBs associated with a plurality of respective SI windows, wherein the adjustment comprises an extension of a respective SI window length of each SI window, of the plurality of respective SI windows, to include the configured number of non-overlapping radio frames.

In some aspects, the adjusted SI window comprises an overlapping portion that overlaps another SI window associated with a third SIB; and block 1110 includes obtaining the second SIB in the overlapping portion.

In some aspects, the first SIB comprises an indication of the configured number of non-overlapping radio frames.

In some aspects, the adjusted SI window is within a configured SI periodicity.

In some aspects, the adjusted SI window is within a configured SI modification period.

In some aspects, block 1110 includes obtaining at least a part of the second SIB in a subframe outside of a configured SI periodicity.

In some aspects, block 1110 includes obtaining at least a part of the second SIB in a subframe outside of a configured SI modification period.

In some aspects, the extension of the SI window length comprises an extension to include a configured number of downlink subframes for obtaining the second SIB.

In some aspects, the configured number of downlink subframes is based on a configured number of retransmissions for the second SIB.

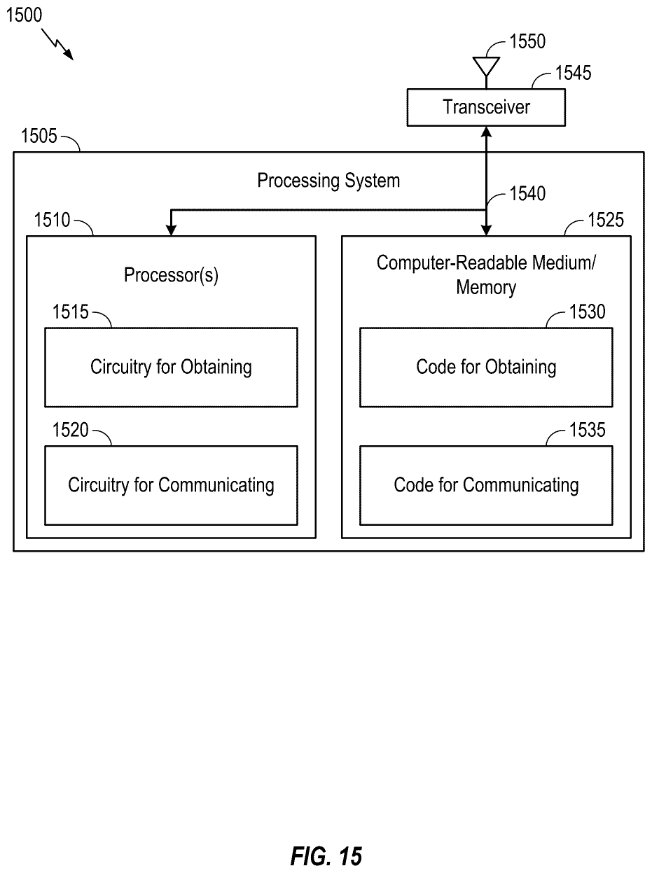

In some aspects, method 1100, or any aspect related to it, may be performed by an apparatus, such as communications device 1500 of FIG. 15, which includes various components operable, configured, or adapted to perform the method 1100. Communications device 1500 is described below in further detail.

In some aspects, due to the adjusted SI window described herein with respect to method 1100, a UE may obtain an SI message without having to wait through one or more frame periodicities for DL communications, such that the UE may select or re-select a cell for improved data rate, etc. earlier than otherwise possible.

Note that FIG. 11 is just one example of a method, and other methods including fewer, additional, or alternative operations are possible consistent with this disclosure.

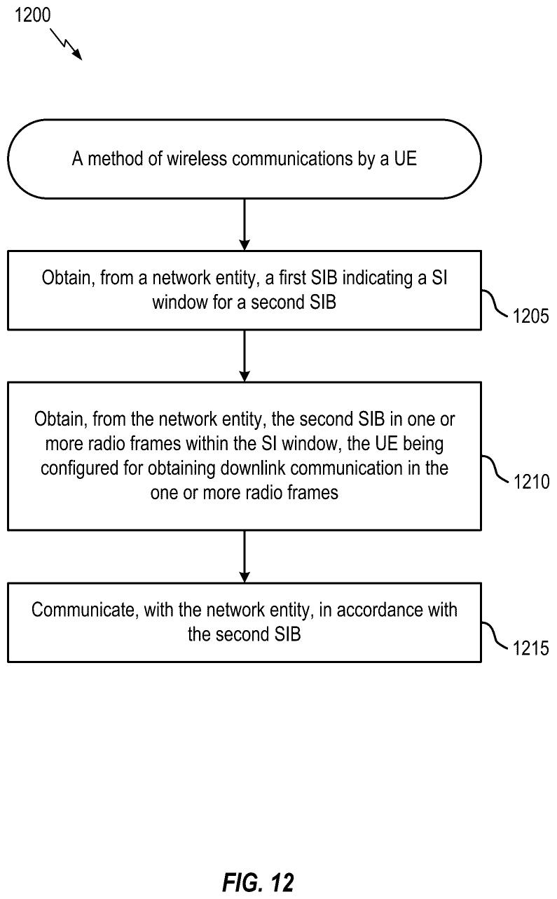

FIG. 12 shows a method 1200 for wireless communications by a UE (e.g., a NB-IoT UE), such as UE 104 of FIG. 1, UE 304 of FIG. 3, UE 504 of FIG. 5, or UE 1004 of FIG. 10.

Method 1200 begins at block 1205 with obtaining, from a network entity, a first SIB indicating a SI window for a second SIB, such as described herein with reference to FIG. 7.

Method 1200 then proceeds to block 1210 with obtaining, from the network entity, the second SIB in one or more radio frames within the SI window, the UE being configured for obtaining downlink communication in the one or more radio frames, such as described herein with reference to FIG. 7.

Method 1200 then proceeds to block 1215 with communicating, with the network entity, in accordance with the second SIB, such as described herein with reference to FIG. 7.

In some aspects, block 1210 includes obtaining the second SIB in a subsequent downlink subframe of a plurality of subsequent downlink subframes of a subsequent radio frame within the SI window, the subsequent radio frame following a first radio frame in which the first SIB is obtained.

In some aspects, block 1210 includes obtaining a retransmission of the second SIB in a second radio frame within the SI window, the second radio frame following the subsequent radio frame.

In some aspects, block 1210 includes ignoring a retransmission of the second SIB outside of the SI window.

In some aspects, method 1200 further includes obtaining, from the network entity, a retransmission of the SIB within a subsequent SI window after a SI periodicity.

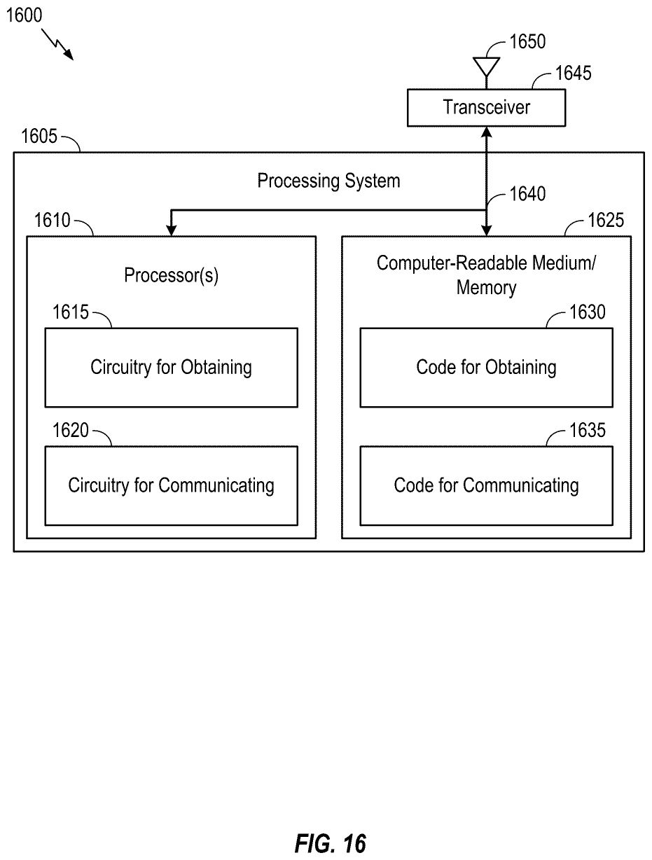

In some aspects, method 1200, or any aspect related to it, may be performed by an apparatus, such as communications device 1600 of FIG. 16, which includes various components operable, configured, or adapted to perform the method 1200. Communications device 1600 is described below in further detail.

In some aspects, method 1200 provides the steps by which a UE may obtain an SI message, which may include information that the UE can use to select or re-select a cell for improved data rate, etc.

Note that FIG. 12 is just one example of a method, and other methods including fewer, additional, or alternative operations are possible consistent with this disclosure.

### Example Operations of a Network Entity

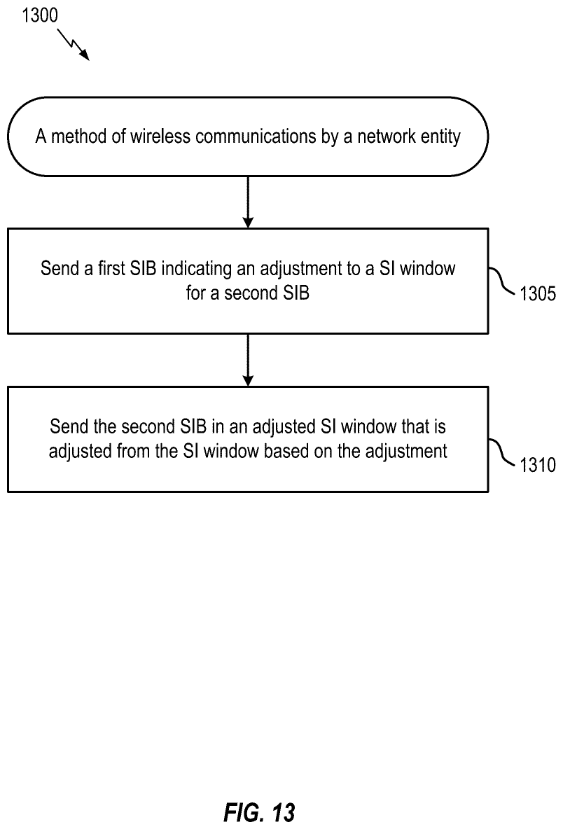

FIG. 13 shows a method 1300 for wireless communications by a network entity, such as BS 102 of FIG. 1, a first network entity 300 or second network entity 302 of FIG. 3, a disaggregated base station as discussed with respect to FIG. 2, the NTN payload 524 depicted and described with respect to FIG. 5, or the network entity 1002 of FIG. 10.

Method 1300 begins at block 1305 with sending a first SIB indicating an adjustment to a SI window for a second SIB. In some aspects, sending the first SIB at block 1305 may correspond to an example of UE 1004 obtaining a first SIB indicating an adjustment to an SI window for a second SIB, as described with respect to 1008 of FIG. 10.

Method 1300 then proceeds to block 1310 with sending the second SIB in an adjusted SI window that is adjusted from the SI window based on the adjustment. In some aspects, sending the second SIB in the adjusted SI window at block 1310 may correspond to an example of UE 1004 obtaining a second SIB in an adjusted SI window, as described with respect to 1010 of FIG. 10.

In some aspects, the adjustment to the SI window is based on an offset value that is specific to the SI window, such as described herein with reference to FIG. 8.

In some aspects, the adjusted SI window, when the offset value is one, starts at a first radio frame or a second radio frame, the first radio frame being a radio frame in which the second SIB is sent, the second radio frame being an immediately following radio frame that immediately follows a start of the SI window.

In some aspects, the adjusted SI window, when the offset value is greater than one, starts at a radio frame that is immediately after a number of radio frames, the number being one less than the offset value, the number of radio frames comprising a first radio frame or a second radio frame, the first radio frame being a radio frame in which the second SIB is sent, the second radio frame being an immediately following radio frame that immediately follows a start of the SI window.

In some aspects, the offset value is based on a configured number of retransmissions of the second SIB.

In certain aspects, method 1300 further includes sending one or more retransmissions of the second SIB, of the configured number of retransmissions of the second SIB, outside of the SI window.

In some aspects, the adjusted SI window is within a configured SI periodicity.

In some aspects, the adjusted SI window is within a configured SI modification period.

In some aspects, block 1310 includes sending at least a part of the second SIB in a subframe outside of a configured SI periodicity (e.g., when the adjustment to the SI window is based on an offset value that is specific to the SI window).

In some aspects, block 1310 includes sending at least a part of the second SIB in a subframe outside of a configured SI modification period (e.g., when the adjustment to the SI window is based on an offset value that is specific to the SI window).

In some aspects, the adjustment comprises an extension of a SI window length of the SI window, such as described herein with reference to FIG. 9.

In some aspects, the extension of the SI window length comprises an extension to include a configured number of non-overlapping radio frames.

In some aspects, the adjustment comprises an extension of a respective SI window length of each SI window, of the plurality of respective SI windows, to include the configured number of non-overlapping radio frames.

In some aspects, the adjusted SI window comprises an overlapping portion that overlaps another SI window associated with a third SIB; and block 1310 includes sending the second SIB in the overlapping portion.

In some aspects, the first SIB comprises an indication of the configured number of non-overlapping radio frames.

In some aspects, the adjusted SI window is within a configured SI periodicity.

In some aspects, the adjusted SI window is within a configured SI modification period.

In some aspects, block 1310 includes sending at least a part of the second SIB in a subframe outside of a configured SI periodicity (e.g., when the adjustment comprises an extension of a SI window length of the SI window).

In some aspects, block 1310 includes sending at least a part of the second SIB in a subframe outside of a configured SI modification period (e.g., when the adjustment comprises an extension of a SI window length of the SI window).

In some aspects, the extension of the SI window length comprises an extension to include a configured number of downlink subframes for sending the second SIB.

In some aspects, the configured number of downlink subframes is based on a configured number of retransmissions for the second SIB.

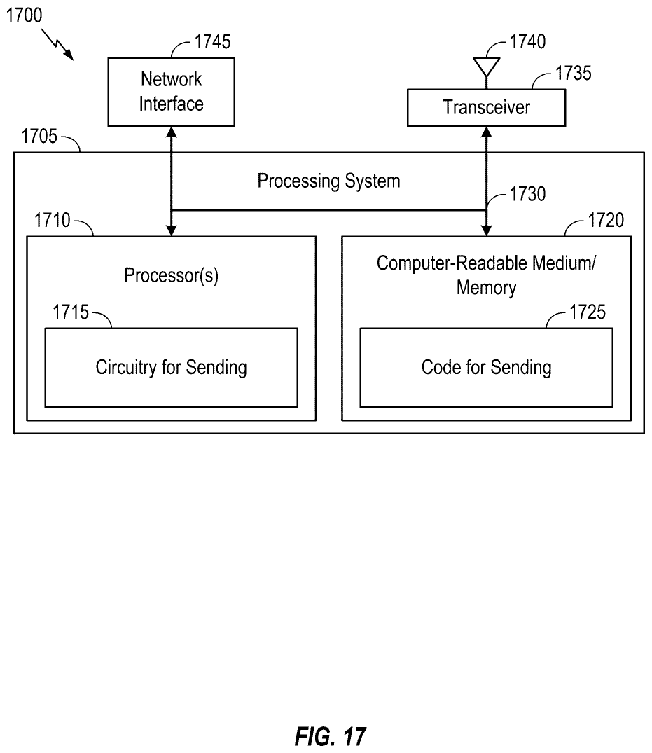

In some aspects, method 1300, or any aspect related to it, may be performed by an apparatus, such as communications device 1700 of FIG. 17, which includes various components operable, configured, or adapted to perform the method 1300. Communications device 1700 is described below in further detail.

Due to the adjusted SI window described herein with respect to method 1300, a network entity may send an SI message which a UE can obtain without having to wait through one or more frame periodicities for DL communications, such that the UE may select or re-select a cell for improved data rate, etc. earlier than otherwise possible.

Note that FIG. 13 is just one example of a method, and other methods including fewer, additional, or alternative operations are possible consistent with this disclosure.

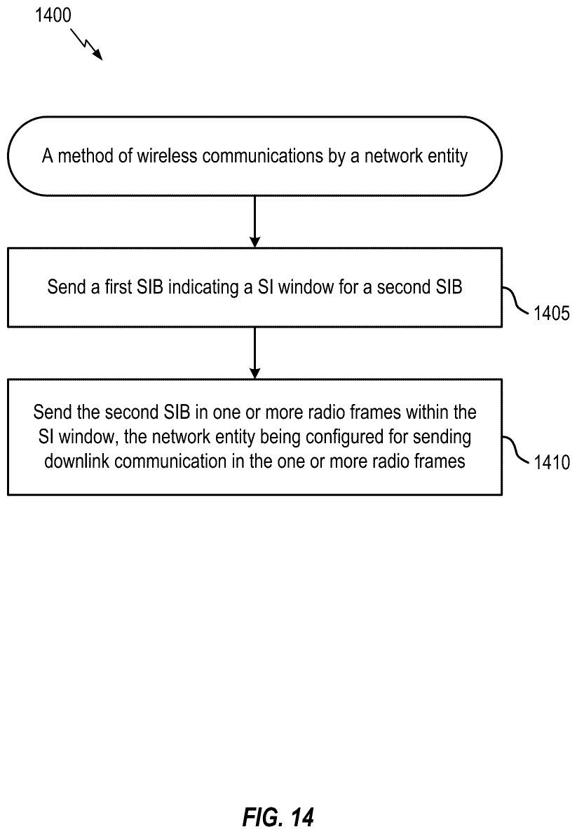

FIG. 14 shows a method 1400 for wireless communications by a network entity, such as BS 102 of FIG. 1, a first network entity 300 or second network entity 302 of FIG. 3, a disaggregated base station as discussed with respect to FIG. 2, the NTN payload 524 depicted and described with respect to FIG. 5, or the network entity 1002 of FIG. 10.

Method 1400 begins at block 1405 with sending a first SIB indicating a SI window for a second SIB, such as described herein with reference to FIG. 7.

Method 1400 then proceeds to block 1410 with sending the second SIB in one or more radio frames within the SI window, the network entity being configured for sending downlink communication in the one or more radio frames, such as described herein with reference to FIG. 7.

In some aspects, block 1410 includes sending the second SIB in a subsequent downlink subframe of a plurality of subsequent downlink subframes of a subsequent radio frame within the SI window, the subsequent radio frame following a first radio frame in which the first SIB is sent.

In some aspects, block 1410 includes sending a retransmission of the second SIB in a second radio frame within the SI window, the second radio frame following the subsequent radio frame.

In some aspects, block 1410 includes sending a retransmission of the second SIB outside of the SI window.

In certain aspects, method 1400 further includes sending a retransmission of the SIB within a subsequent SI window after a SI periodicity.

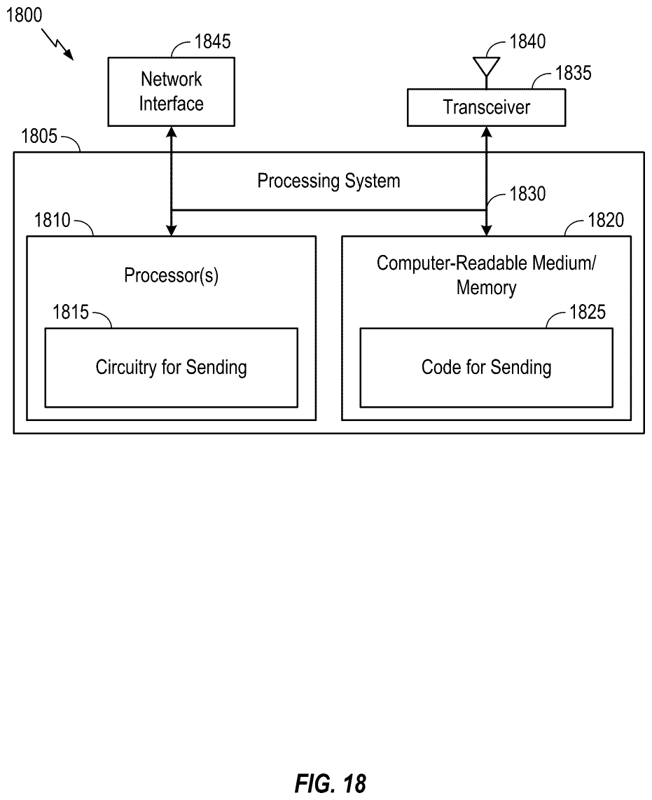

In some aspects, method 1400, or any aspect related to it, may be performed by an apparatus, such as communications device 1800 of FIG. 18, which includes various components operable, configured, or adapted to perform the method 1400. Communications device 1800 is described below in further detail.

In some aspects, method 1400 provides the steps by which a network entity may send an SI message, which may include information that the UE can use to select or re-select a cell for improved data rate, etc.

Note that FIG. 14 is just one example of a method, and other methods including fewer, additional, or alternative operations are possible consistent with this disclosure.

### Example Communications Devices

FIG. 15 depicts aspects of an example communications device 1500 configured for wireless communications. In some aspects, communications device 1500 is a user equipment, such as UE 104 described above with respect to FIG. 1, UE 304 described with respect to FIG. 3, UE 504 of FIG. 5, or UE 1004 of FIG. 10.

The communications device 1500 includes a processing system 1505 coupled to a transceiver 1545 (e.g., a transmitter and/or a receiver). The transceiver 1545 is configured to transmit and receive signals for the communications device 1500 via an antenna 1550, such as the various signals as described herein. The processing system 1505 may be configured to perform processing functions for the communications device 1500, including processing signals received and/or to be transmitted by the communications device 1500.

The processing system 1505 includes one or more processors 1510 and a computer-readable medium/memory 1525. In various aspects, the one or more processors 1510 may be representative of the one or more processors 318 described with respect to FIG. 3. The one or more processors 1510 are coupled to a computer-readable medium/memory 1525 via a bus 1540. In some aspects, the computer-readable medium/memory 1525 may be representative of the one or more memories 320 described with respect to FIG. 3. The computer-readable medium/memory 1525 is a non-transitory computer-readable medium/memory. In certain aspects, the computer-readable medium/memory 1525 is configured to store instructions (e.g., computer-executable code), that when executed by the one or more processors 1510, cause the one or more processors 1510 to perform the method 1100 described with respect to FIG. 11, or any aspect related to it, including any operations described in relation to FIG. 11. Note that reference to a processor performing a function of communications device 1500 may include one or more processors performing that function of communications device 1500, such as in a distributed fashion.

In the depicted example, computer-readable medium/memory 1525 stores code (e.g., executable instructions), including code for obtaining 1530 and code for communicating 1535. Processing of the code 1530 and 1535 may enable and cause the communications device 1500 to perform the method 1100 described with respect to FIG. 11, or any aspect related to it. For instance, in some aspects, code for obtaining 1530 includes code for obtaining, from a network entity, a first SIB indicating an adjustment to a SI window for a second SIB. In some aspects, code for obtaining 1530 includes code for obtaining, from the network entity, the second SIB in an adjusted SI window that is adjusted from the SI window based on the adjustment. In some aspects, code for communicating 1535 includes code for communicating, with the network entity, in accordance with the second SIB.

The one or more processors 1510 include circuitry configured to implement (e.g., execute) the code stored in the computer-readable medium/memory 1525, including circuitry for obtaining 1515 and circuitry for communicating 1520. Processing with circuitry 1515 and 1520 may enable and cause the communications device 1500 to perform the method 1100 described with respect to FIG. 11, or any aspect related to it. For instance, in some aspects, circuitry for obtaining 1515 includes circuitry for obtaining, from a network entity, a first SIB indicating an adjustment to a SI window for a second SIB. In some aspects, circuitry for obtaining 1515 includes circuitry for obtaining, from the network entity, the second SIB in an adjusted SI window that is adjusted from the SI window based on the adjustment. In some aspects, circuitry for communicating 1520 includes circuitry for communicating, with the network entity, in accordance with the second SIB.

More generally, means for communicating, transmitting, sending or outputting for transmission may include the one or more transceivers 324, one or more antenna 322 and/or processing system 316 of the UE 304 illustrated in FIG. 3, transceiver 1545 and/or antenna 1550 of the communications device 1500 in FIG. 15, and/or one or more processors 1510 of the communications device 1500 in FIG. 15. Means for communicating, receiving or obtaining may include the one or more transceivers 324, one or more antennas 322, and/or processing system 316 of the UE 304 illustrated in FIG. 3, transceiver 1545 and/or antenna 1550 of the communications device 1500 in FIG. 15, and/or one or more processors 1510 of the communications device 1500 in FIG. 15.

FIG. 16 depicts aspects of an example communications device 1600 configured for wireless communications. In some aspects, communications device 1600 is a user equipment, such as UE 104 described above with respect to FIG. 1, UE 304 described with respect to FIG. 3, UE 504 of FIG. 5, or UE 1004 of FIG. 10.

The communications device 1600 includes a processing system 1605 coupled to a transceiver 1645 (e.g., a transmitter and/or a receiver). The transceiver 1645 is configured to transmit and receive signals for the communications device 1600 via an antenna 1650, such as the various signals as described herein. The processing system 1605 may be configured to perform processing functions for the communications device 1600, including processing signals received and/or to be transmitted by the communications device 1600.

The processing system 1605 includes one or more processors 1610 and a computer-readable medium/memory 1625. In various aspects, the one or more processors 1610 may be representative of the one or more processors 318 described with respect to FIG. 3. The one or more processors 1610 are coupled to a computer-readable medium/memory 1625 via a bus 1640. In some aspects, the computer-readable medium/memory 1625 may be representative of the one or more memories 320 described with respect to FIG. 3. The computer-readable medium/memory 1625 is a non-transitory computer-readable medium/memory. In certain aspects, the computer-readable medium/memory 1625 is configured to store instructions (e.g., computer-executable code), that when executed by the one or more processors 1610, cause the one or more processors 1610 to perform the method 1200 described with respect to FIG. 12, or any aspect related to it, including any operations described in relation to FIG. 12. Note that reference to a processor performing a function of communications device 1600 may include one or more processors performing that function of communications device 1600, such as in a distributed fashion.

In the depicted example, computer-readable medium/memory 1625 stores code (e.g., executable instructions), including code for obtaining 1630 and code for communicating 1635. Processing of the code 1630 and 1635 may enable and cause the communications device 1600 to perform the method 1200 described with respect to FIG. 12, or any aspect related to it. For instance, in some aspects, code for obtaining 1630 includes code for obtaining, from a network entity, a first SIB indicating a SI window for a second SIB. In some aspects, code for obtaining 1630 includes code for obtaining, from the network entity, the second SIB in one or more radio frames within the SI window, the UE being configured for obtaining downlink communication in the one or more radio frames. In some aspects, code for communicating 1635 includes code for communicating, with the network entity, in accordance with the second SIB.

The one or more processors 1610 include circuitry configured to implement (e.g., execute) the code stored in the computer-readable medium/memory 1625, including circuitry for obtaining 1615 and circuitry for communicating 1620. Processing with circuitry 1615 and 1620 may enable and cause the communications device 1600 to perform the method 1200 described with respect to FIG. 12, or any aspect related to it. For instance, in some aspects, circuitry for obtaining 1615 includes circuitry for obtaining, from a network entity, a first SIB indicating a SI window for a second SIB. In some aspects, circuitry for obtaining 1615 includes circuitry for obtaining, from the network entity, the second SIB in one or more radio frames within the SI window, the UE being configured for obtaining downlink communication in the one or more radio frames. In some aspects, circuitry for communicating 1620 includes circuitry for communicating, with the network entity, in accordance with the second SIB.

More generally, means for communicating, transmitting, sending or outputting for transmission may include the one or more transceivers 324, one or more antenna 322 and/or processing system 316 of the UE 304 illustrated in FIG. 3, transceiver 1645 and/or antenna 1650 of the communications device 1600 in FIG. 16, and/or one or more processors 1610 of the communications device 1600 in FIG. 16. Means for communicating, receiving or obtaining may include the one or more transceivers 324, one or more antennas 322, and/or processing system 316 of the UE 304 illustrated in FIG. 3, transceiver 1645 and/or antenna 1650 of the communications device 1600 in FIG. 16, and/or one or more processors 1610 of the communications device 1600 in FIG. 16.

FIG. 17 depicts aspects of an example communications device configured for wireless communications. In some aspects, communications device 1700 is a network entity, such as BS 102 of FIG. 1, first network entity 300 or second network entity 302 of FIG. 3, a disaggregated base station as discussed with respect to FIG. 2, the NTN payload 524 depicted and described with respect to FIG. 5, or the network entity 1002 of FIG. 10.

The communications device 1700 includes a processing system 1705 coupled to a transceiver 1735 (e.g., a transmitter and/or a receiver) and/or a network interface 1745. The transceiver 1735 is configured to transmit and receive signals for the communications device 1700 via an antenna 1740, such as the various signals as described herein. The network interface 1745 is configured to obtain and send signals for the communications device 1700 via communications link(s), such as a backhaul link, midhaul link, and/or fronthaul link as described herein, such as with respect to FIG. 2. The processing system 1705 may be configured to perform processing functions for the communications device 1700, including processing signals received and/or to be transmitted by the communications device 1700.

The processing system 1705 includes one or more processors 1710 and a computer-readable medium/memory 1720. In various aspects, one or more processors 1710 may be representative of the one or more processors 308, as described with respect to FIG. 3. The one or more processors 1710 are coupled to the computer-readable medium/memory 1720 via a bus 1730. In certain aspects, the computer-readable medium/memory 1720 is configured to store instructions (e.g., computer-executable code), including code for sending 1725, that when executed by the one or more processors 1710, cause the one or more processors 1710 to perform the method 1300 described with respect to FIG. 13, or any aspect related to it, including any operations described in relation to FIG. 13. The computer-readable medium/memory 1720 is a non-transitory computer-readable medium/memory. Note that reference to a processor of communications device 1700 performing a function may include one or more processors of communications device 1700 performing that function, such as in a distributed fashion.

In the depicted example, the computer-readable medium/memory 1720 stores code (e.g., executable instructions), including code for sending 1725. Processing of the code for sending 1725 may enable and cause the communications device 1700 to perform the method 1300 described with respect to FIG. 13, or any aspect related to it. For instance, in some aspects, code for sending 1725 includes code for sending a first SIB indicating an adjustment to a SI window for a second SIB. In some aspects, code for sending 1725 includes code for sending the second SIB in an adjusted SI window that is adjusted from the SI window based on the adjustment.

The one or more processors 1710 include circuitry configured to implement (e.g., execute) the code stored in the computer-readable medium/memory 1720, including circuitry for sending 1715. Processing with circuitry for sending 1715 may enable and cause the communications device 1700 to perform the method 1300 described with respect to FIG. 13, or any aspect related to it. For instance, in some aspects, circuitry for sending 1715 includes circuitry for sending a first SIB indicating an adjustment to a SI window for a second SIB. In some aspects, circuitry for sending 1715 includes circuitry for sending the second SIB in an adjusted SI window that is adjusted from the SI window based on the adjustment.

Various components of the communications device 1700 may provide means for performing the method 1300 described with respect to FIG. 13, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1735, antenna 1740, and/or network interface 1745 of the communications device 1700 in FIG. 17, and/or one or more processors 1710 of the communications device 1700 in FIG. 17. Means for communicating, receiving or obtaining may include the one or more transceivers 312, one or more antennas 314, and/or processing system 306 of the first network entity 300 or the second network entity 302 illustrated in FIG. 3, transceiver 1735, antenna 1740, and/or network interface 1745 of the communications device 1700 in FIG. 17, and/or one or more processors 1710 of the communications device 1700 in FIG. 17.

FIG. 18 depicts aspects of an example communications device configured for wireless communications. In some aspects, communications device 1800 is a network entity, such as BS 102 of FIG. 1, first network entity 300 or second network entity 302 of FIG. 3, a disaggregated base station as discussed with respect to FIG. 2, the NTN payload 524 depicted and described with respect to FIG. 5, or the network entity 1002 of FIG. 10.

The communications device 1800 includes a processing system 1805 coupled to a transceiver 1835 (e.g., a transmitter and/or a receiver) and/or a network interface 1845. The transceiver 1835 is configured to transmit and receive signals for the communications device 1800 via an antenna 1840, such as the various signals as described herein. The network interface 1845 is configured to obtain and send signals for the communications device 1800 via communications link(s), such as a backhaul link, midhaul link, and/or fronthaul link as described herein, such as with respect to FIG. 2. The processing system 1805 may be configured to perform processing functions for the communications device 1800, including processing signals received and/or to be transmitted by the communications device 1800.

The processing system 1805 includes one or more processors 1810 and a computer-readable medium/memory 1820. In various aspects, one or more processors 1810 may be representative of the one or more processors 308, as described with respect to FIG. 3. The one or more processors 1810 are coupled to the computer-readable medium/memory 1820 via a bus 1830. In certain aspects, the computer-readable medium/memory 1820 is configured to store instructions (e.g., computer-executable code), including code for sending 1825, that when executed by the one or more processors 1810, cause the one or more processors 1810 to perform the method 1400 described with respect to FIG. 14, or any aspect related to it, including any operations described in relation to FIG. 14. The computer-readable medium/memory 1820 is a non-transitory computer-readable medium/memory. Note that reference to a processor of communications device 1800 performing a function may include one or more processors of communications device 1800 performing that function, such as in a distributed fashion.

In the depicted example, the computer-readable medium/memory 1820 stores code (e.g., executable instructions), including code for sending 1825. Processing of the code for sending 1825 may enable and cause the communications device 1800 to perform the method 1400 described with respect to FIG. 14, or any aspect related to it. For instance, in some aspects, code for sending 1825 includes code for sending a first SIB indicating a SI window for a second SIB. In some aspects, code for sending 1825 includes code for sending the second SIB in one or more radio frames within the SI window, the network entity being configured for sending downlink communication in the one or more radio frames.

The one or more processors 1810 include circuitry configured to implement (e.g., execute) the code stored in the computer-readable medium/memory 1820, including circuitry for sending 1815. Processing with circuitry for sending 1815 may enable and cause the communications device 1800 to perform the method 1400 described with respect to FIG. 14, or any aspect related to it. For instance, in some aspects, circuitry for sending 1815 includes circuitry for sending a first SIB indicating a SI window for a second SIB. In some aspects, circuitry for sending 1815 includes circuitry for sending the second SIB in one or more radio frames within the SI window, the network entity being configured for sending downlink communication in the one or more radio frames.

Various components of the communications device 1800 may provide means for performing the method 1400 described with respect to FIG. 14, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1835, antenna 1840, and/or network interface 1845 of the communications device 1800 in FIG. 18, and/or one or more processors 1810 of the communications device 1800 in FIG. 18. Means for communicating, receiving or obtaining may include the one or more transceivers 312, one or more antennas 314, and/or processing system 306 of the first network entity 300 or the second network entity 302 illustrated in FIG. 3, transceiver 1835, antenna 1840, and/or network interface 1845 of the communications device 1800 in FIG. 18, and/or one or more processors 1810 of the communications device 1800 in FIG. 18.

### Example Clauses

Implementation examples are described in the following numbered clauses:
Clause 1: A method for wireless communications by a UE, the method comprising: obtaining, from a network entity, a first SIB indicating an adjustment to a SI window for a second SIB; obtaining, from the network entity, the second SIB in an adjusted SI window that is adjusted from the SI window based on the adjustment; and communicating, with the network entity, in accordance with the second SIB.
Clause 2: The method of Clause 1, wherein the adjustment to the SI window is based on an offset value that is specific to the SI window.
Clause 3: The method of Clause 2, wherein the adjusted SI window, when the offset value is one, starts at a first radio frame or a second radio frame, the first radio frame being a radio frame in which the second SIB is obtained, the second radio frame being an immediately following radio frame that immediately follows a start of the SI window.
Clause 4: The method of Clause 2, wherein the adjusted SI window, when the offset value is greater than one, starts at a radio frame that is immediately after a number of radio frames, the number being one less than the offset value, the number of radio frames comprising a first radio frame or a second radio frame, the first radio frame being a radio frame in which the second SIB is obtained, the second radio frame being an immediately following radio frame that immediately follows a start of the SI window.
Clause 5: The method of Clause 2, wherein the offset value is based on a configured number of retransmissions of the second SIB.
Clause 6: The method of Clause 5, further comprising obtaining one or more retransmissions of the second SIB, of the configured number of retransmissions of the second SIB, outside of the SI window.
Clause 7: The method of any one of Clauses 1-6, wherein the adjusted SI window is within a configured SI periodicity.
Clause 8: The method of any one of Clauses 1-7, wherein the adjusted SI window is within a configured SI modification period.
Clause 9: The method of any one of Clauses 1-8, wherein obtaining the second SIB comprises obtaining at least a part of the second SIB in a subframe outside of a configured SI periodicity.
Clause 10: The method of any one of Clauses 1-9, wherein obtaining the second SIB comprises obtaining at least a part of the second SIB in a subframe outside of a configured SI modification period.
Clause 11: The method of any one of Clauses 1-10, wherein the adjustment comprises an extension of a SI window length of the SI window.
Clause 12: The method of Clause 11, wherein the extension of the SI window length comprises an extension to include a configured number of non-overlapping radio frames.
Clause 13: The method of Clause 12, wherein obtaining the second SIB comprises obtaining a plurality of SIBs associated with a plurality of respective SI windows, wherein the adjustment comprises an extension of a respective SI window length of each SI window, of the plurality of respective SI windows, to include the configured number of non-overlapping radio frames.
Clause 14: The method of Clause 12, wherein: the adjusted SI window comprises an overlapping portion that overlaps another SI window associated with a third SIB; and obtaining the second SIB in the adjusted SI window comprises obtaining the second SIB in the overlapping portion.
Clause 15: The method of Clause 12, wherein the first SIB comprises an indication of the configured number of non-overlapping radio frames.
Clause 16: The method of Clause 11, wherein the adjusted SI window is within a configured SI periodicity.
Clause 17: The method of Clause 11, wherein the adjusted SI window is within a configured SI modification period.
Clause 18: The method of Clause 11, wherein obtaining the second SIB comprises obtaining at least a part of the second SIB in a subframe outside of a configured SI periodicity.
Clause 19: The method of Clause 11, wherein obtaining the second SIB comprises obtaining at least a part of the second SIB in a subframe outside of a configured SI modification period.
Clause 20: The method of Clause 11, wherein the extension of the SI window length comprises an extension to include a configured number of downlink subframes for obtaining the second SIB.
Clause 21: The method of Clause 20, wherein the configured number of downlink subframes is based on a configured number of retransmissions for the second SIB.
Clause 22: A method of wireless communications by a UE, the method comprising: obtaining, from a network entity, a first SIB indicating a SI window for a second SIB; obtaining, from the network entity, the second SIB in one or more radio frames within the SI window, the UE being configured for obtaining downlink communication in the one or more radio frames; and communicating, with the network entity, in accordance with the second SIB.
Clause 23: The method of Clause 22, wherein obtaining the second SIB in the one or more radio frames within the SI window comprises obtaining the second SIB in a subsequent downlink subframe of a plurality of subsequent downlink subframes of a subsequent radio frame within the SI window, the subsequent radio frame following a first radio frame in which the first SIB is obtained.
Clause 24: The method of Clause 23, wherein obtaining the second SIB in the one or more radio frames within the SI window further comprises obtaining a retransmission of the second SIB in a second radio frame within the SI window, the second radio frame following the subsequent radio frame.
Clause 25: The method of any one of Clauses 22-24, wherein obtaining the second SIB in the one or more radio frames within the SI window comprises ignoring a retransmission of the second SIB outside of the SI window.
Clause 26: The method of any one of Clauses 22-25, further comprising obtaining, from the network entity, a retransmission of the SIB within a subsequent SI window after a SI periodicity.
Clause 27: A method for wireless communications by a network entity comprising: sending a first SIB indicating an adjustment to a SI window for a second SIB; and sending the second SIB in an adjusted SI window that is adjusted from the SI window based on the adjustment.
Clause 28: The method of Clause 27, wherein the adjustment to the SI window is based on an offset value that is specific to the SI window.
Clause 29: The method of Clause 28, wherein the adjusted SI window, when the offset value is one, starts at a first radio frame or a second radio frame, the first radio frame being a radio frame in which the second SIB is sent, the second radio frame being an immediately following radio frame that immediately follows a start of the SI window.
Clause 30: The method of Clause 28, wherein the adjusted SI window, when the offset value is greater than one, starts at a radio frame that is immediately after a number of radio frames, the number being one less than the offset value, the number of radio frames comprising a first radio frame or a second radio frame, the first radio frame being a radio frame in which the second SIB is sent, the second radio frame being an immediately following radio frame that immediately follows a start of the SI window.
Clause 31: The method of Clause 28, wherein the offset value is based on a configured number of retransmissions of the second SIB.
Clause 32: The method of Clause 31, further comprising sending one or more retransmissions of the second SIB, of the configured number of retransmissions of the second SIB, outside of the SI window.
Clause 33: The method of any one of Clauses 27-32, wherein the adjusted SI window is within a configured SI periodicity.
Clause 34: The method of any one of Clauses 27-33, wherein the adjusted SI window is within a configured SI modification period.
Clause 35: The method of any one of Clauses 27-34, wherein sending the second SIB comprises sending at least a part of the second SIB in a subframe outside of a configured SI periodicity.
Clause 36: The method of any one of Clauses 27-35, wherein sending the second SIB comprises sending at least a part of the second SIB in a subframe outside of a configured SI modification period.
Clause 37: The method of any one of Clauses 27-36, wherein the adjustment comprises an extension of a SI window length of the SI window.
Clause 38: The method of Clause 37, wherein the extension of the SI window length comprises an extension to include a configured number of non-overlapping radio frames.
Clause 39: The apparatus of Clause 38, sending the second SIB comprises sending a plurality of SIBs associated with a plurality of respective SI windows, wherein the adjustment comprises an extension of a respective SI window length of each SI window, of the plurality of respective SI windows, to include the configured number of non-overlapping radio frames.
Clause 40: The method of Clause 38, wherein: the adjusted SI window comprises an overlapping portion that overlaps another SI window associated with a third SIB; and sending the second SIB in the adjusted SI window comprises sending the second SIB in the overlapping portion.
Clause 41: The method of Clause 38, wherein the first SIB comprises an indication of the configured number of non-overlapping radio frames.
Clause 42: The method of Clause 37, wherein the adjusted SI window is within a configured SI periodicity.
Clause 43: The method of Clause 37, wherein the adjusted SI window is within a configured SI modification period.
Clause 44: The method of Clause 37, wherein sending the second SIB comprises sending at least a part of the second SIB in a subframe outside of a configured SI periodicity.
Clause 45: The method of Clause 37, wherein sending the second SIB comprises sending at least a part of the second SIB in a subframe outside of a configured SI modification period.
Clause 46: The method of Clause 37, wherein the extension of the SI window length comprises an extension to include a configured number of downlink subframes for sending the second SIB.
Clause 47: The method of Clause 46, wherein the configured number of downlink subframes is based on a configured number of retransmissions for the second SIB.
Clause 48: A method of wireless communications by a network entity, comprising: sending a first SIB indicating a SI window for a second SIB; and sending the second SIB in one or more radio frames within the SI window, the network entity being configured for sending downlink communication in the one or more radio frames.
Clause 49: The method of Clause 48, wherein sending the second SIB in the one or more radio frames within the SI window comprises sending the second SIB in a subsequent downlink subframe of a plurality of subsequent downlink subframes of a subsequent radio frame within the SI window, the subsequent radio frame following a first radio frame in which the first SIB is sent.
Clause 50: The method of Clause 49, wherein sending the second SIB in the one or more radio frames within the SI window further comprises sending a retransmission of the second SIB in a second radio frame within the SI window, the second radio frame following the subsequent radio frame.
Clause 51: The method of any one of Clauses 48-50, wherein sending the second SIB in the one or more radio frames within the SI window comprises sending a retransmission of the second SIB outside of the SI window.
Clause 52: The method of any one of Clauses 48-51, further comprising sending a retransmission of the SIB within a subsequent SI window after a SI periodicity.
Clause 53: One or more apparatuses, comprising: one or more memories comprising executable instructions; and one or more processors configured to execute the executable instructions and cause the one or more apparatuses to perform a method in accordance with any one of clauses 1-52.
Clause 54: One or more apparatuses configured for wireless communications, comprising: one or more memories; and one or more processors, coupled to the one or more memories, configured to cause the one or more apparatuses to perform a method in accordance with any one of Clauses 1-52.
Clause 55: One or more apparatuses configured for wireless communications, comprising: one or more memories; and one or more processors, coupled to the one or more memories, configured to perform a method in accordance with any one of Clauses 1-52.
Clause 56: One or more apparatuses, comprising means for performing a method in accordance with any one of Clauses 1-52.
Clause 57: One or more non-transitory computer-readable media comprising executable instructions that, when executed by one or more processors of one or more apparatuses, cause the one or more apparatuses to perform a method in accordance with any one of Clauses 1-52.
Clause 58: One or more computer program products embodied on one or more computer-readable storage media comprising code for performing a method in accordance with any one of Clauses 1-52.
Clause 59: A user equipment (UE), comprising: a processing system that includes processor circuitry and memory circuitry that stores code and is coupled with the processor circuitry, the processing system configured to cause the UE to perform a method in accordance with any one of Clauses 1-26.
Clause 60: A network entity, comprising: a processing system that includes processor circuitry and memory circuitry that stores code and is coupled with the processor circuitry, the processing system configured to cause the network entity to perform a method in accordance with any one of Clauses 27-52.
Clause 61: One or more apparatuses configured for wireless communications, comprising: a processing system that includes one or more processors and one or more memories coupled with the one or more processors, the processing system configured to cause the one or more apparatuses to perform a method in accordance with any one of Clauses 1-52.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a user equipment (UE) to:
obtain, from a network entity, a first system information block (SIB) indicating an adjustment to a system information (SI) window for a second SIB;
obtain, from the network entity, the second SIB in an adjusted SI window that is adjusted from the SI window based on the adjustment; and
communicate, with the network entity, in accordance with the second SIB.

2. The apparatus of claim 1, wherein the adjustment to the SI window is based on an offset value that is specific to the SI window.

3. The apparatus of claim 2, wherein the adjusted SI window, when the offset value is one, starts at a first radio frame or a second radio frame, the first radio frame being a radio frame in which the second SIB is obtained, the second radio frame being an immediately following radio frame that immediately follows a start of the SI window.

4. The apparatus of claim 2, wherein the adjusted SI window, when the offset value is greater than one, starts at a radio frame that is immediately after a number of radio frames, the number being one less than the offset value, the number of radio frames comprising a first radio frame or a second radio frame, the first radio frame being a radio frame in which the second SIB is obtained, the second radio frame being an immediately following radio frame that immediately follows a start of the SI window.

5. The apparatus of claim 2, wherein the offset value is based on a configured number of retransmissions of the second SIB.

6. The apparatus of claim 5, wherein the processing system is further configured to cause the UE to obtain one or more retransmissions of the second SIB, of the configured number of retransmissions of the second SIB, outside of the SI window.

7. The apparatus of claim 1, wherein the adjusted SI window is within a configured SI periodicity.

8. The apparatus of claim 1, wherein the adjusted SI window is within a configured SI modification period.

9. The apparatus of claim 1, where to cause the UE to obtain the second SIB, the processing system is configured to cause the UE to obtain at least a part of the second SIB in a subframe outside of a configured SI periodicity.

10. The apparatus of claim 1, where to cause the UE to obtain the second SIB, the processing system is configured to cause the UE to obtain at least a part of the second SIB in a subframe outside of a configured SI modification period.

11. The apparatus of claim 1, wherein the adjustment comprises an extension of a SI window length of the SI window.

12. The apparatus of claim 11, wherein the extension of the SI window length comprises an extension to include a configured number of non-overlapping radio frames.

13. The apparatus of claim 12, wherein to cause the UE to obtain the second SIB, the processing system is configured to cause the UE to obtain a plurality of SIBs associated with a plurality of respective SI windows, wherein the adjustment comprises an extension of a respective SI window length of each SI window, of the plurality of respective SI windows, to include the configured number of non-overlapping radio frames.

14. The apparatus of claim 12, wherein:
the adjusted SI window comprises an overlapping portion that overlaps another SI window associated with a third SIB; and
to obtain the second SIB in the adjusted SI window, the processing system is configured to cause the UE to obtain the second SIB in the overlapping portion.

15. The apparatus of claim 12, wherein the first SIB comprises an indication of the configured number of non-overlapping radio frames.

16. The apparatus of claim 11, wherein the extension of the SI window length comprises an extension to include a configured number of downlink subframes for obtaining the second SIB.

17. The apparatus of claim 16, wherein the configured number of downlink subframes is based on a configured number of retransmissions for the second SIB.

18. The apparatus of claim 1, wherein:
the adjusted SI window comprises a valid downlink subframe that is used for downlink communications, and
to cause the UE to obtain, from the network entity, the second SIB in the adjusted SI window that is adjusted from the SI window, the processing system is configured to cause the UE to obtain the second SIB in the valid downlink subframe, wherein at least a part of the second SIB was scheduled on an invalid downlink subframe that is not used for downlink communications within the SI window.

19. A method of wireless communications by a narrowband Internet-of-Things (NB-IoT) user equipment (UE), comprising:
obtaining, from a network entity, a first system information block (SIB) indicating a system information (SI) window for a second SIB;
obtaining, from the network entity, the second SIB in one or more radio frames within the SI window, the UE being configured for obtaining downlink communication in the one or more radio frames; and
communicating, with the network entity, in accordance with the second SIB.

20. A method for wireless communications by a user equipment (UE), the method comprising:
obtaining, from a network entity, a first system information block (SIB) indicating an adjustment to a system information (SI) window for a second SIB;
obtaining, from the network entity, the second SIB in an adjusted SI window that is adjusted from the SI window based on the adjustment; and
communicating, with the network entity, in accordance with the second SIB.
